(19) United States
(12) Patent Application Publication
(10) Pub. No.: US 2025/0337763 A1
(43) Pub. Date: Oct. 30, 2025

(54) HYPERTEXT MARKUP LANGUAGE (HTML) CONTENT ANALYSIS USING MACHINE LEARNING

(71) Applicant: Centripetal Networks, LLC, Portsmouth, NH (US)

(72) Inventors: Shamir Smith, St. Thomas, VI (US); Daniel Rogers, Reston, VA (US); Vincent Mutolo, New York, NY (US); Sean Moore, Hollis, NH (US); Alexander Chinchilli, Medford, MA (US); Connor Tess, merrimack, NH (US); Bashiri Smith, St. Thomas, VI (US)

(21) Appl. No.: 19/192,671

(22) Filed: Apr. 29, 2025

Related U.S. Application Data
(60) Provisional application No. 63/640,454, filed on Apr. 30, 2024.
(60) Provisional application No. 63/690,544, filed on Sep. 4, 2024.

(51) Int. Cl. H04L 9/40

(52) U.S. Cl. CPC H04L 63/1425; H04L 63/1416

(57) ABSTRACT

HyperText Markup Language (HTML) content analysis (HCA) using machine learning is described. A feature vector schema may be generated based on domain names corresponding to HTML webpages and corresponding indications of a status of the HTML webpage. The schema may map each position in a feature vector of a given HTML webpage to a resource identifier. Information may be processed using the schema to generate respective feature vectors. The feature vectors may be used to train a model to generate risk indicators for HTML webpages. A potentially parked domain webpage or a potentially malicious domain webpage may be received. A feature vector for the webpage may be generated and inputted to the model. The model may generate a risk indicator for the webpage. The risk indicator may be output and may cause responsive actions. The model may be updated based on a determination indicating whether the webpage was a parked domain webpage or a malicious domain webpage.

### CROSS-REFERENCE TO RELATED APPLICATIONS

This application is a continuation of and claims the benefit of U.S. Provisional Application No. 63/690,544, filed Sep. 4, 2024 and titled “HYPERTEXT MARKUP LANGUAGE (HTML) CONTENT ANALYSIS USING MACHINE LEARNING,” and U.S. Provisional Application No. 63/640,454, filed Apr. 30, 2024 and titled “HYPERTEXT MARKUP LANGUAGE (HTML) CONTENT ANALYSIS USING MACHINE LEARNING.” Each of the above-referenced applications is hereby incorporated by reference in its entirety.

### BACKGROUND

Malicious actors continually develop and refine methods of conducting cyber attacks over the Internet to evade conventional cybersecurity technology. One such method involves embedding malicious content (e.g., viruses, HyperText Markup Language (HTML) injection, Structured Query Language (SQL) injection, Cross-Site Scripting, and/or other malicious content) into the source code (e.g., HTML source code) of an HTML webpage on the Internet. Specifically, the malicious actors may embed the malicious content in the source code of an HTML file that may be executed and/or otherwise accessed by a web browser (e.g., via a client device, such as a personal computer, laptop, tablet, mobile phone, smart watch, and/or other client devices) and which corresponds to a webpage that may be displayed by the web browser. Other such methods may involve HTML webpages that may appear to be legitimate and safe but actually may be malicious and may be designed to collect sensitive data from users that may have been deceived by the apparent legitimacy of a webpage. Such webpages and their associated hosts may be described, in some examples, as data exfiltration websites.

For example, malicious actors may create a malicious HTML webpage by embedding malicious content in one or more assets (e.g., network assets such as text content, graphics, photographs, video files, audio files, databases, uniform resource locator (URL) links to webpages, and/or other assets) included in the source code of a website, creating malicious assets. In some instances, the malicious assets may be directly included in the source code. For example, a malicious actor may add source code to the malicious HTML webpage that causes a prompt to appear on a visitor's web browser when they access the malicious HTML webpage. The prompt may request, for example, sensitive credentials and/or other personal information from the visitor. Additionally or alternatively, in some examples, the malicious assets may be stored and/or otherwise maintained in a remote location (e.g., a web server remote from the web server hosting the malicious HTML webpage) but may be embedded in the malicious HTML webpage's source code by way of an inbound URL link. For example, a malicious actor may embed a URL link in the source code and cause said URL link to be displayed, via a visitor's browser, on the malicious HTML web site. If the visitor selects (e.g., by clicking, and/or by other means) the URL link, the visitor may be routed, redirected, and/or otherwise transferred to the malicious asset associated with the URL link.

Conventional methods of detecting and responding to cyber threats/attacks embedded in a malicious HTML webpage may include blocking a visitor from accessing the malicious HTML webpage, reporting the malicious HTML webpage to a cybersecurity service, and/or other methods. Conventional methods may additionally or alternatively include techniques such as sandboxing. Sandboxing may be and/or comprise processes whereby a potentially malicious HTML webpage is accessed (e.g., via a web browser) from within an isolated “sandbox” environment, such as a virtual machine or the like, allowing the webpage to be examined in a secure manner. Once sandboxed, a human cyberanalyst may visually inspect the webpage, test the webpage's functionality, and/or otherwise determine whether the webpage is a malicious HTML webpage. However, conventional methods may be inadequate for distinguishing between malicious and legitimate HTML webpages prior to a user accessing the webpage. For example, malicious actors may embed malicious functionality in the HTML source code of a webpage without embedding a malicious asset, causing a malicious webpage to appear as a legitimate webpage. In such examples, conventional methods of detecting and responding to cyber threats/attacks may fail to detect, prior to a user accessing an HTML webpage, that the HTML webpage corresponds to a malicious HTML webpage due to the lack of malicious assets. And to the extent conventional preventative measures (such as sandboxing) exist to attempt to address these deficiencies, such conventional preventative measures are inefficient. Sandboxing, for example, requires skilled human labor and expertise in the form of human cyberanalysts, and is limited by the speed and/or resources available to such cyberanalysts. Thus, there exists a need for comprehensive, reliable, secure, accurate, fast, and efficient automated methods for generating risk indicators for potentially malicious HTML webpages and initiating cybersecurity actions (e.g., preventative actions, mitigation actions, and/or remediation actions) configured to prevent and/or respond to malicious cyber threats/attacks.

### SUMMARY

The following presents a simplified summary in order to provide a basic understanding of some aspects of the disclosure. It is intended neither to identify key or critical elements of the disclosure nor to delineate the scope of the disclosure. The following summary merely presents some concepts of the disclosure in a simplified form as a prelude to the description below.

Aspects of this disclosure relate to performing HyperText Markup Language Content Analysis (HCA) to detect whether a potentially malicious HTML webpage corresponds to an actually malicious HTML webpage based on assets included in the HTML webpage. In some examples, malicious actors may embed malicious functionality and/or content in an HTML webpage comprising assets associated with legitimate HTML webpages. HCA may be used to review, parse, and/or otherwise analyze assets of known malicious HTML webpages, of known legitimate HTML webpages, and of known parked domain HTML webpages (e.g., HTML webpages corresponding to registered domain names that are not associated with an active/developed service) to generate a schema for identifying whether an HTML webpage comprising similar assets is concealing malicious functionality and/or content. The schema may identify similarities between the legitimate and/or unknown assets embedded in malicious HTML webpages and may be used to generate, for potentially malicious HTML webpage, indications of a likelihood that the potentially malicious HTML webpage corresponds to a malicious HTML webpage based on the assets included in the potentially malicious HTML webpage.

Accordingly, some aspects described herein provide methods and devices for performing HTML content analysis (e.g., for the purpose of efficiently determining the maliciousness of a potentially malicious HTML webpage). A method for HTML content analysis may comprise receiving a training set comprising a plurality of training records. The training records may each respectively comprise a domain name corresponding to an HTML webpage and an indication of a previous determination as to whether the corresponding HTML webpage corresponds to a malicious HTML webpage. The method may generate a feature vector schema for the training set. The feature vector schema may correspond to all assets referenced in the training set. The method may generate the feature vector schema by parsing the HTML webpage for each respective domain name of the training set to identify a set of resource identifiers of network assets referenced in the HTML webpages. Parsing a given HTML webpage may comprise extracting resource identifiers of each asset referenced in the given HTML webpage and generating the set of resource identifiers based on the extracted resource identifiers of each asset referenced in the given HTML webpage. The method may further generate the feature vector schema based on the set of resource identifiers of network assets referenced in the HTML webpages. The feature vector schema may map each position in a feature vector of a given HTML webpage to a corresponding resource identifier of the set of resource identifiers. The method may process each training record of the training set, using the feature vector schema, to generate a feature vector corresponding to the HTML webpage for each respective domain name of the training set.

Based on generating the feature vector schema, the method may train a content analysis model based on inputting, into the content analysis model and for each respective domain name of the training set, the feature vector of the respective HTML webpage and the corresponding indication of the previous determination as to whether the corresponding HTML webpage corresponds to a malicious HTML webpage. The method may comprise receiving a request to perform content analysis on a potentially malicious HTML webpage. Based on the request, the method may generate a feature vector for the potentially malicious HTML webpage by processing the potentially malicious HTML webpage using the feature vector schema. The method may generate a risk indicator based on inputting the feature vector for the potentially malicious HTML webpage into the content analysis model. The risk indicator may correspond to a likelihood that the potentially malicious HTML webpage corresponds to a malicious HTML webpage. The method may comprise causing output of the risk indicator and receiving, based on output of the risk indicator, a determination indicating whether the potentially malicious HTML webpage corresponds to a malicious HTML webpage. The method may provide the feature vector for the potentially malicious HTML webpage and the determination indicating whether the potentially malicious HTML webpage corresponds to a malicious HTML webpage to the content analysis model as a new training record and retrain the content analysis model based on the new training record.

In one or more arrangements, processing a given training record may comprise generating the feature vector for the given training record. The feature vector for the given training record may comprise one or more binary bits indicating the presence of resource identifiers, of the set of resource identifiers, in the HTML webpage for each respective domain name. The method may generate the feature vector by determining, based on the feature vector schema and for each position of the feature vector for the given training record, whether the HTML webpage page includes a resource identifier corresponding to the resource identifier mapped to the respective position and assigning a binary value to each position of the feature vector for the given training record.

In one or more examples, the method that may process the potentially malicious HTML webpage may comprise extracting resource identifiers corresponding to each asset referenced in the potentially malicious HTML webpage. The method may determine, based on the feature vector schema and for each position of the feature vector for the potentially malicious HTML webpage, whether the potentially malicious HTML webpage includes a resource identifier corresponding to the resource identifier mapped to the respective position. The method may further assign a binary value to each position of the feature vector for the potentially malicious HTML webpage. In one or more arrangements, generating the feature vector schema may comprise determining, by parsing the set of resource identifiers, whether the set of resource identifiers includes one or more duplicate resource identifiers. The one or more duplicate resource identifiers may each be identical to a first resource identifier. Based on determining the set of resource identifiers includes one or more duplicate resource identifiers, the method may remove, from the set of resource identifiers, each of the one or more duplicate resource identifiers before mapping each position in the feature vector of the given HTML webpage to the corresponding resource identifier of the set of resource identifiers.

In one or more examples, the method may generate the feature vector schema by determining, by parsing the set of resource identifiers, whether the set of resource identifiers includes one or more resource identifiers sharing a same domain name subpart. Based on determining the set of resource identifiers includes one or more resource identifiers sharing the same domain name subpart the method may map, for two given resource identifiers sharing the same domain name subpart, the two given resource identifiers sharing the same domain name subpart to the same position in the feature vector of the given HTML webpage. In one or more arrangements, the method may generate the feature vector schema by determining, by parsing the set of resource identifiers, whether the set of resource identifiers includes one or more alias resource identifiers. A given alias resource identifier may correspond to a known resource identifier included in the set of resource identifiers. Based on determining the set of resource identifiers includes one or more alias resource identifiers, the method may map the given alias resource identifier and the corresponding known resource identifier to the same position in the feature vector of the given HTML webpage.

In one or more examples, the method may receive the request to perform content analysis based on monitoring network traffic of a computing device. The monitoring may comprise identifying a list of HTML webpage domain names included in the network traffic and comparing the list of HTML webpage domain names with a watchlist of potentially malicious domain names. In one or more arrangements, receiving the request to perform content analysis may be based on determining a given HTML webpage exceeds a risk threshold value. The method may determine whether a given HTML webpage exceeds a risk threshold value by receiving a set of threat information comprising a plurality of threat records maintained by a cybersecurity application. Each threat record may comprise a domain name corresponding to a tracked HTML webpage and a confidence score associated with the domain name. The confidence score may indicate a likelihood that the tracked HTML webpage corresponds to a malicious HTML webpage. The method may determine, based on comparing a domain name corresponding to the first HTML webpage to the set of threat information, whether or not the domain name corresponding to the first HTML webpage is included in the set of threat information. Based on determining that the domain name corresponding to the first HTML webpage is included in the set of threat information and based on comparing the confidence score associated with the domain name of the first HTML webpage to the risk threshold value, the method may determine whether or not the confidence score exceeds the risk threshold value.

In one or more examples, the method may receive the request to perform HTML content analysis (HCA) on HTML webpages corresponding to domain names included in a set of potentially malicious domain names. Applying HCA techniques, as described herein, to an HTML webpage corresponding to a domain name in the set of potentially malicious domain names may result in likelihood scores indicating that the corresponding website may be malicious, legitimate, or parked. In the context of HCA as described herein, a parked domain website where the parking mechanism is comprised of DNS name server (NS) records and a parked domain website where the parking mechanism is comprised of one or more wildcard DNS records (e.g., DNS records corresponding to non-existent domain names) that resolve to or otherwise map to a parked domain website may be mutually referred to as a parked/wildcard domain website. For example, HCA may determine a domain name to be associated with a parked domain website regardless of the mechanism used to map the domain name to the website. Accordingly, an HTML file corresponding to a parked/wildcard domain website may be referred to as a parked/wildcard domain HTML webpage. Because of the potential for cyber threats and/or attacks, communications with parked/wildcard domain websites may be prevented or otherwise protected against. For example, by implementing HCA techniques as described herein on parked/wildcard domain HTML webpages, one or more cyber threats (e.g., cyber attacks utilizing adware at the parked/wildcard domain HTML webpage as an attack vector) may be prevented or otherwise protected against. After applying HCA to an HTML webpage corresponding to a domain name, the resultant likelihood scores for the malicious, legitimate, and parked/wildcard categories may be compared to threshold values for each category. If a threshold value is met or exceeded for a category, then the domain name may be inserted in a subset of domain names associated with the category. If none of the threshold values for the categories are met or exceeded, then the domain name may be inserted in a subset associated with an unknown or indeterminate category.

In one or more arrangements, the method of causing output of the subsets associated with the categories may cause at least one of: generation of one or more packet filtering rules configured to block traffic associated with the domain names in a category, generation of one or more packet filtering rules configured to permit traffic associated with the domain names in a category, or updating of one or more packet filtering rules configured to perform a first packet filtering action on traffic associated with the domain names in a category. Updating the one or more packet filtering rules may reconfigure the one or more packet filtering rules to perform a second packet filtering action different from the first packet filtering action. In one or more examples, causing output of the subsets may cause one or more of: generation of a first threat intelligence record comprising a domain name in a subset or updating of a second threat intelligence record that comprises a domain name in a subset.

In one or more examples, the feature vector schema may further map a position in the feature vector of the given HTML webpage to a number of webpage redirects associated with a request to access the given HTML webpage. In one or more arrangements, the feature vector schema may further map a position in the feature vector of the given HTML webpage to a percentage of central processing unit usage of a computing device receiving a request to access the given HTML webpage. In one or more examples, the feature vector schema may further map a position in the feature vector of the given HTML webpage to a number of return functions a request to access the given HTML webpage causes a web browser to execute. In one or more arrangements, the feature vector schema may further map a position in the feature vector of the given HTML webpage to a number of variant webpages associated with the given HTML webpage. A request to display the given HTML webpage may cause, based on an IP address corresponding to the request, display of a given variant webpage.

In one or more examples, the method may determine, based on the feature vector for the potentially malicious HTML webpage, a first asset absent from the potentially malicious HTML webpage. The first asset may be associated with malicious HTML webpages. The method may modify the risk indicator based on determining that the first asset is absent from the potentially malicious HTML webpage and output the modified risk indicator. In one or more arrangements, modifying the risk indicator may comprise determining a weight associated with the first asset, where the weight corresponds to a likelihood that the first asset indicates a malicious HTML webpage. The method may adjust the risk indicator based on the weight. In one or more examples, the risk indicator may comprise a confidence score indicating the likelihood that the potentially malicious HTML webpage corresponds to a malicious HTML webpage. The confidence score may be based on one or more of: a determination that a number of assets, associated with one or more known malicious HTML webpages and identified by the feature vector for the potentially malicious HTML webpage, exceeds a threshold number of assets, or a determination that a percentage of assets, associated with one or more known malicious HTML webpages and identified by the feature vector for the potentially malicious HTML webpage, exceeds a threshold percentage of assets, or a determination that a similarity score indicating a correlation between the feature vector for the potentially malicious HTML webpage and one or more feature vectors for one or more HTML webpages corresponding to domain names of the training set exceeds a threshold value.

In one or more arrangements, the method of causing output of the risk indicator may cause at least one of: generation of one or more packet filtering rules configured to block traffic associated with the potentially malicious HTML webpage, generation of one or more packet filtering rules configured to permit traffic associated with the potentially malicious HTML webpage, or updating of one or more packet filtering rules configured to perform a first packet filtering action. Updating the one or more packet filtering rules may reconfigure the one or more packet filtering rules to perform a second packet filtering action different from the first packet filtering action. In one or more examples, causing output of the risk indicator may cause one or more of: generation of a first threat intelligence record comprising a domain name corresponding to the potentially malicious HTML webpage or updating of a second threat intelligence record that comprises the domain name corresponding to the potentially malicious HTML webpage.

Computing devices, systems, and computer readable media storing instructions for implementing these methods are also disclosed herein.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings, in which like reference numerals refer to similar elements, and wherein:

FIGS. 1A-1B show an example computing environment and associated platform for performing HyperText Markup Language Content Analysis (HCA) in accordance with one or more example arrangements;

FIG. 2 shows an example input and output system for a platform configured to perform HCA in accordance with one or more example arrangements;

FIG. 3 shows an example method for training a content analysis model for performing HCA in accordance with one or more example arrangements.

FIG. 4 shows an example method for generating a feature vector schema to perform HCA in accordance with one or more example arrangements.

FIG. 5 shows an example method for performing HCA on a potentially malicious HTML webpage in accordance with one or more example arrangements.

FIG. 6 shows an example method of generating a feature vector for a potentially malicious HTML webpage to perform HCA in accordance with one or more example arrangements.

FIG. 7 shows an example method of modifying a risk indicator (e.g., a risk indicator generated during HCA) based on undetected assets in accordance with one or more example arrangements.

FIG. 8 shows examples of feature vectors generated during HCA in accordance with one or more example arrangements.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the disclosure. In addition, reference is made to particular applications, protocols, and embodiments in which aspects of the disclosure may be practiced. It is to be understood that other applications, protocols, and embodiments may be utilized, and structural and functional modifications may be made, without departing from the scope of the disclosure. It is to be understood that networks may be any combination of physical or virtual, wired or wireless, logical or actual, on-premises or in the cloud, and geographically or logically distributed.

Aspects of this disclosure relate to techniques for performing HTML content analysis (HCA). For example, HCA techniques may be used to identify potentially malicious HTML webpages and initiate cybersecurity actions (e.g., preventative/protective actions, mitigation actions, and/or remediation actions) configured to prevent and/or respond to malicious cyber threats/attacks corresponding to the identified malicious HTML webpages. For another example, HCA techniques may be used to identify potentially parked/wildcard domain HTML webpages and initiate cybersecurity actions (e.g., preventative/protective actions, mitigation actions, and/or remediation actions) configured to prevent and/or respond to cyber threats/attacks corresponding to the identified parked/wildcard domain HTML webpages. These techniques may be employed by an entity (e.g., an organization, such as a Cyber-Security-as-a-Service (CSaaS) provider, and/or other organizations) that provides cybersecurity services to users who access the Internet via a client device. HCA techniques may include generating a risk indicator for a potentially malicious HTML webpage based on comparing the assets of an HTML webpage with data gathered on the assets of known legitimate and known malicious webpages.

The identification of potentially malicious HTML webpages may leverage databases or data structures of cyber threat intelligence (CTI) that are available from many CTI provider organizations. This CTI may include indicators, or threat indicators, or Indicators-of-Compromise (IoCs). The CTI may include Internet network addresses—in the form of TP addresses, IP address ranges, IP addresses in combination with L4/transport layer ports and/or L3/Internet layer protocol types (e.g., “5-tuples,” or the like), domain names, URIs, and the like—of resources, e.g. Internet hosts, that may be controlled/operated by threat actors, or that may have otherwise been associated with malicious activity. The CTI indicators/threat indicators may also include identifiers for certificates and associated certificate authorities that are used to secure some TCP/IP communications (e.g., X.509 certificates used by the TLS protocol to secure HTTP-mediated sessions). The CTI may further include a list and/or feed of known malicious assets and/or assets included in or associated with known malicious HTML webpages that may, e.g., have been gathered from one or more known malicious HTML webpages, such as by performing HCA and/or other cybersecurity operations. The CTI may also include a list of known legitimate assets that may, e.g., have been gathered from one or more known legitimate webpages (e.g., frequently trafficked webpages identified as being free of malicious content, test webpages created to serve as training data for cybersecurity algorithms and/or models, and/or other legitimate webpages).

HCA techniques may be performed via a computing device (e.g., a server, personal computer, laptop, tablet, mobile phone, and/or other computing devices). HCA techniques may be utilized by a CSaaS provider. The CSaaS provider may offer various protections to its subscribers/customers configured to prevent associated malicious webpage and parked/wildcard domain webpage threats and/or attacks. For example, a machine learning model may be used to identify potentially malicious webpages and parked/wildcard domain webpages, output a risk indicator (for example, a binary value or confidence score indicating the likelihood that a potentially malicious HTML webpage corresponds to a malicious HTML webpage), and/or perform other HCA techniques described herein. The machine learning model may be a content analysis model trained using information derived from a set of training records that each include (1) a domain name corresponding to an HTML webpage and (2) an indication of a determination as to whether the HTML webpage corresponds to a malicious HTML webpage or a parked/wildcard domain HTML webpage (which may, e.g., be a determination of a cyberanalyst, such as an employee of a CSaaS provider, and/or other cyberanalysts). In some instances, the training records may be sourced from and/or separately included in CTI generated by a CTI provider and may include domain names associated with HTML webpages corresponding to legitimate webpages with known legitimate assets, HTML webpages corresponding to malicious webpages with known legitimate assets and/or unknown assets, HTML webpages corresponding to malicious webpages with known malicious assets, and HTML webpages corresponding to parked/wildcard domain webpages with known and/or unknown parking assets.

A feature vector schema (e.g., a binary asset representation (BAR) schema, or the like) may be used to identify potentially malicious HTML webpages, potentially legitimate HTML webpages, and potentially parked/wildcard domain HTML webpages. The feature vector schema may be representative of steps used to process information derived from training records used to train a machine learning model, such as the content analysis model described above. The feature vector schema may outline steps for parsing HTML webpages corresponding to HTML webpage domain names included in training records to extract resource identifiers of assets (e.g., names, signatures, links (e.g., URL links to webpages), and/or other methods of identifying the source and/or location of an asset) and generating a feature vector that includes a string of binary values indicating the presence or absence of an asset mapped to each position in the string of binary values.

An example implementation of HCA techniques described herein may identify potentially malicious webpages by using a content analysis model trained using a feature vector schema. Similar implementations and techniques may identify potentially legitimate webpages and/or potentially parked/wildcard domain webpages. For example, the feature vector schema may be used to process training records and generate feature vectors, such as BARs, of all the assets for each respective HTML webpage corresponding to a set of training records. The content analysis model may be trained to identify potentially malicious HTML webpages based on the feature vectors and the corresponding indications of a determination as to whether each respective HTML webpage corresponds to a malicious HTML webpage. HCA may be performed on HTML webpages and/or domain names corresponding to the HTML webpages that are potentially malicious (e.g., webpages that are not known malicious webpages, that are not known legitimate webpages, and that are not known parked/wildcard domain webpages) by generating a feature vector of the potentially malicious HTML webpage and inputting the feature vector into the content analysis model. The content analysis model may generate and output a risk indicator (e.g., a binary value or confidence score indicating the likelihood that a potentially malicious HTML webpage corresponds to a malicious HTML webpage) and cause output of the risk indicator.

Based on outputting the risk indicator, a determination (e.g., from a human cyberanalyst and/or a machine cyberanalyst, and/or other sources) may be received indicating whether the potentially malicious HTML webpage corresponds to a malicious HTML webpage. This determination and the feature vector of the potentially malicious HTML webpage may be used as a new training record to retrain the content analysis model. In doing so, the efficiency and accuracy of the content analysis model may be improved by updating the pool of information used to generate risk indicators based on input of feature vectors. By performing HCA on potentially malicious HTML webpages, a CTI provider may discover potentially malicious HTML webpages and/or potentially malicious assets that have not yet been identified and then publish the domain names corresponding to the potentially malicious HTML webpages (e.g., after identifying the potentially malicious HTML webpage as a malicious HTML webpage), and/or the potentially malicious assets in one or more CTI feeds. Subscribers to the CTI feed, for example a CSaaS provider, may then use the provided information to proactively protect their networks and/or clients from malicious content embedded in HTML webpages.

HCA techniques described herein may comprise receiving a training set of training records respectively comprising a domain name corresponding to an HTML webpage and an indication of a previous determination as to whether the corresponding HTML webpage corresponds to a malicious HTML webpage. A feature vector (e.g., BAR) schema may be generated for processing training records. The feature vector schema may map each position (e.g., each individual binary bit in a string of binary bits) in a feature vector, such as a BAR, to a particular resource identifier (e.g., asset names (e.g., a file name, or the like), domain names, signatures, links (e.g., URL links to webpages), and/or other methods of identifying the source and/or location of an asset). The feature vector schema may be used to process each training record in the training set to generate a feature vector, such as a BAR, for each respective HTML webpage corresponding to the domain names of the training set. These feature vectors for each respective HTML webpage may be input into the content analysis model along with the corresponding indication as to whether the domain name and/or corresponding HTML webpage is and/or corresponds to a malicious HTML webpage.

HCA techniques described herein may be implemented upon receiving a request (e.g., a service request, such as a request received by a service implementing and/or configured to implement HCA, an automated request caused by a trigger (e.g., an indication, message, and/or other notification that a threat event log, for example a log of a communication event that may be associated with a threat, includes a domain name corresponding to a potentially malicious HTML webpage), and/or a request from a user, such as a client and/or subscriber to a CSaaS provider, an employee of a CSaaS provider, and/or other users). The request may be and/or include a request to perform HCA on a domain name to identify whether a corresponding potentially malicious HTML webpage is malicious. HCA techniques described herein may further comprise generating a feature vector (e.g., a BAR) for the potentially malicious HTML webpage. The BAR may be used as input for the content analysis model, and such input may cause output of a risk indicator (e.g., a binary value and/or confidence score indicating the likelihood that a potentially malicious HTML webpage corresponds to a malicious HTML webpage). HCA techniques described herein may involve causing output of the risk indicator (e.g., to a CSaaS provider, a CTI provider, and/or other entities). Based on the output of the risk indicator, a device and/or service implementing the HCA techniques described herein may receive a determination (e.g., from a cyberanalyst associated with a CSaaS, and/or from other sources) indicating whether the domain name of the potentially malicious HTML webpage corresponds to a malicious HTML webpage. The content analysis model may be retrained and/or otherwise updated based on a new training record comprising the feature vector corresponding to the potentially malicious HTML webpage and the determination indicating whether the domain name of the potentially malicious HTML webpage corresponds to a malicious HTML webpage (e.g., an indication that the cyberanalyst determined the potentially malicious HTML webpage was malicious or an indication that the cyberanalyst determined the potentially malicious HTML webpage was not malicious).

One or more systems, apparatuses, methods and/or computer readable media herein may be used for implementing an HCA solution. An HCA solution may perform HCA on potentially malicious HTML webpages and/or corresponding domain names in “soft real time”, such as in single-digit milliseconds on average. An HCA solution may comprise as an input one or more potentially malicious HTML webpages (retrieved by, for example, using a web browser's HTTP client to obtain the HTML webpage corresponding to a potentially malicious domain name, retrieved from a database of previously obtained HTML webpages indexed by domain name, and/or retrieved by other means/from other sources), and/or may produce as one or more outputs one or more risk indicators corresponding to a likelihood a respective HTML webpage of the one or more potentially malicious HTML webpages corresponds to a malicious HTML webpage. The one or more outputs may be used by a CSaaS provider to provide protections to subscribers/customers.

A CSaaS provider may offer one or more cyber protections, such as network protections for cyber threats and/or attacks, to its subscribers/customers. A general approach to network protections that a CSaaS provider may employ may comprise the following procedures. A CSaaS provider may collect cyber threat intelligence (CTI). CTI may comprise information in the form of TP addresses, domain names, URLs, and/or any other information of known cyber threats. A CSaaS provider may translate the CTI into one or more packet filtering rules. A CSaaS provider may configure one or more inline packet filtering devices located at one or more Internet access points in subscriber(s)' network(s) with the one or more rules and/or associated policies. A CSaaS provider may configure the packet filtering devices to apply the rules and/or policies to traffic (e.g., all packet traffic) between a subscriber's network and the Internet. Any in-transit packet that matches a CTI-based rule may have the rule's/policy's protective action(s) (e.g., block, allow, log, capture, etc., the packet) applied to it and/or to the other packets in the same flow (e.g., packets with the same bi-directional 5-tuple values) as the CTI-matching packet. The associated flow of packets may be called a threat event. The associated packet logs may be aggregated into a threat event log. The threat event logs may be sent to a security operations center (SOC). The SOC may be operated by the CSaaS provider, for example, for processing, analysis, and/or remediation of the associated threat and/or attack.

An example of an HCA process and/or solution described herein may involve a CSaaS provider. The CSaaS provider may identify HTML webpages (e.g., via a domain name associated with the HTML webpage, and/or by other means) in its subscribers'/customers' threat event logs that are potentially malicious (e.g., the HTML webpages are not known legitimate HTML webpages or known malicious HTML webpages or known parked/wildcard domain HTML webpages). Based on a risk indicator corresponding to a potentially malicious HTML webpage and generated as part of an HCA process, the CSaaS provider may augment the threat event log(s) accordingly (for example, by increasing the likelihood that the potentially malicious HTML webpage may be investigated by a cyberanalyst (e.g., a human cyberanalyst and/or a machine cyberanalyst) for possible reporting to the associated CSaaS subscriber/customer; or for example, in the case of a low-risk value of the risk indicator, signaling a human cyberanalyst not to waste time and resources investigating the webpage). Another example application of an HCA solution described herein is that the CSaaS provider may apply a solution to a CTI database maintained by a CTI provider and/or the CSaaS provider. The CSaaS provider may enhance/augment the CTI associated with any potentially malicious HTML webpage or potentially parked/wildcard domain HTML webpage, for example, by storing and/or otherwise maintaining the risk indicator in association with a domain name of the potentially malicious HTML webpage or potentially parked/wildcard domain HTML webpage. By storing and/or otherwise maintaining the risk indicator in association with the domain name the HCA process may cause, by previously outputting the risk indicator, the domain name to be exempted from additional/future instances of the HCA process and/or may cause the domain name to be removed from a threat event log, CTI feed, or the like, thus conserving computing time and resources and thereby increasing efficiency of processes for identifying whether HTML webpages/websites corresponding to domain names are malicious or legitimate or parking.

Another example of an HCA process and/or solution described herein may involve sets of domain names that may be, for example, provided by a CTI provider organization or a CSaaS provider organization, or for example, created by a domain name generation process, such as the domain name generation processes described in U.S. Pat. No. 11,856,005, filed Sep. 16, 2022 and titled “MALICIOUS HOMOGLYHPIC DOMAIN NAME GENERATION AND ASSOCIATED CYBER SECURITY OPERATIONS” which is hereby incorporated by reference in its entirety. A CSaaS provider organization may apply HCA to HTML webpages corresponding to each domain name in a set of domain names to compute a likelihood score that the corresponding website may be malicious, legitimate, or parking. After applying HCA to an HTML webpage corresponding to a domain name, the resultant likelihood scores for the malicious, legitimate, and parked/wildcard categories may be compared to threshold values for each category. If a threshold value is met or exceeded for a category, then the domain name may be inserted in a subset associated with the category. If none of the threshold values for the categories are met or exceeded, then the domain name may be inserted in a subset associated with an unknown or indeterminate category. These subsets for each category may be utilized, for example, by creating new or updated/modified CTI feeds for each category which may be, for example, translated into packet filtering rules and applied to network traffic for network protection purposes.

Additionally, in some examples, by storing or caching domain names and associated risk indicators in, for example, an efficient index data structure, such as the efficient data structures described in U.S. patent application Ser. No. 18/672,353, filed May 23, 2024 and titled “METHODS AND SYSTEMS FOR EFFICIENT CYBERSECURITY POLICY ENFORCEMENT ON NETWORK COMMUNICATIONS”, which is hereby incorporated in its entirety by reference, an HCA process may cause the risk indicator for an HTML webpage corresponding to a domain name to be retrieved efficiently, for example, within microseconds or faster. For example, a large CSaaS provider may process thousands of threat event logs per second, and may manage millions of domain names supplied by CTI providers. In these examples, by outputting the risk indicator and causing the risk indicator to be stored in an efficient data index structure, an HCA process may efficiently associate risk indicators to domain names and include the indicators and domain names in an associated threat event log in microseconds or faster, providing secure, reliable, and fast processing of threat event logs and domain names that offer improvements over conventional methods. Additionally or alternatively, in addition to the risk indicator, other relevant information associated with a domain name may be stored in these efficient index data structures, such as the current BAR for the HTML webpage or even the HTML webpage itself, in order to reduce retrieval times for such information. The applications described herein may comprise the CSaaS provider applying the HCA solution to domain names, associated with potentially malicious HTML webpages, that are contained in packets being filtered by packet-filtering devices at CSaaS providers' customer networks, and/or that are included in CTI that is applied to packets by the packet-filtering devices. A CSaaS provider may use other HCA-based applications with a broader scope of applicability, and/or in different contexts, as described further herein.

CTI may be supplied by one or more CTI provider organizations. CTI may comprise network threat intelligence reports and/or associated network threat indicators in the form of TP addresses, 5-tuples, domain names, URLs, and/or any other form, of hosts and/or resources that may be associated with network threats and/or attacks. CTI may additionally or alternatively comprise certificates, certificate authorities, or the like. CTI consumers, such as network administrators, cyberanalysts, cybersecurity applications, CSaaS providers, and/or any other entity or device may use CTI to identify and/or remediate threats and/or attacks on the network(s) they are protecting. CTI providers may supply network threat indicators in structured files and/or streams that may be referred to as CTI feeds. A CTI feed may be characterized by indicator type (e.g., TP address, domain name, URL, etc.), threat type (e.g., ransomware, botnet, reconnaissance, etc.), confidence level (e.g., low, medium, high), and/or any other characteristic. For example, a CTI feed may be identified as a low-confidence feed based on a corresponding low confidence in threat indicators (e.g., domain names, or the like) included in the CTI feed corresponding to actual threats.

Described herein are systems, methods, apparatuses, and computer readable media for performing HCA. Various cyber network defense applications may be enabled by, and/or benefit from, automated and/or user-initiated performance of HCA. Some examples of these applications are described herein.

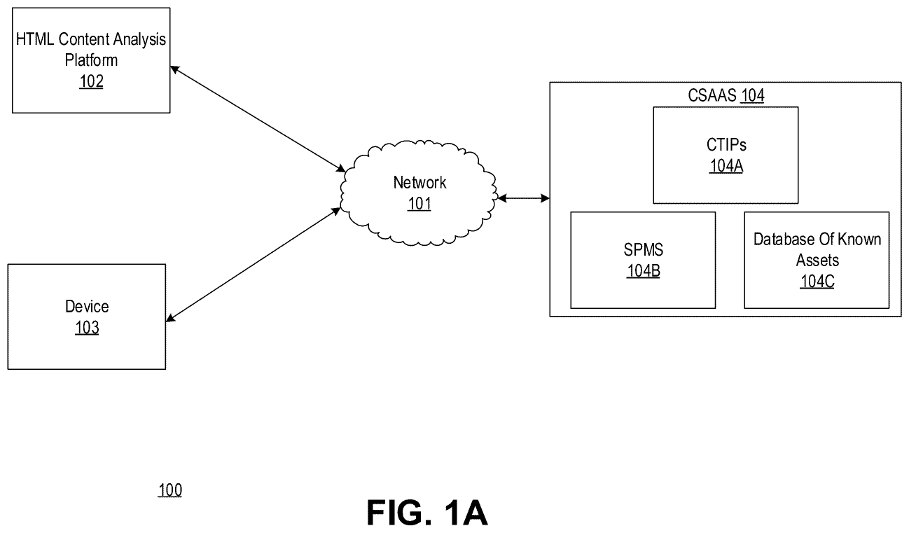

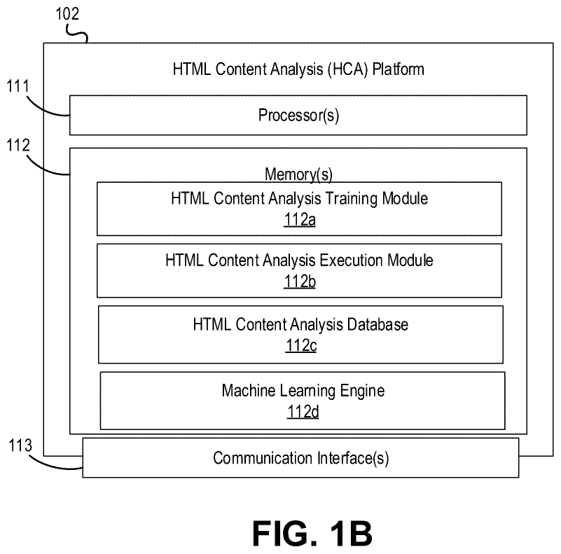

FIGS. 1A-1B show an example computing environment and associated computing platform for performing HCA in accordance with one or more example arrangements. Referring to FIG. 1A, a computing environment 100 may comprise any quantity of providers and/or provider equipment, such as a Cyber-Security-as-a-Service (CSaaS) 104 that may be securing/protecting one or more private network(s), which may, e.g., subscribe to and/or be a customer of one or more cyber threat intelligence (CTI) providers (CTIPs) 104A that may provide CTI feeds to the CSaaS 104. The computing environment 100 may comprise any quantity of computing devices, such as one or more of: an HTML content analysis (HCA) platform 102, a device 103, and/or other devices.

As described further below, HCA platform 102 may be a computer system that includes one or more computing devices (e.g., servers, laptop computers, desktop computers, mobile devices, tablets, smartphones, and/or other devices) and/or other computer components (e.g., processors, memories, communication interfaces) that may be used to implement methods for performing HCA. In some instances, HCA platform 102 may be and/or comprise one or more computing devices, hosting a service for performing HCA, that may be accessed by, contacted by, connected to, and/or otherwise corresponding to a computing device corresponding to a user (e.g., an employee of a CSaaS, such as a cyberanalyst and/or other employee, and/or other users). In one or more examples, the HCA platform 102 may be configured to communicate with one or more systems (e.g., device 103, CSaaS 104, and/or other systems) to perform an information transfer (e.g., send/receive information such as CTI, training records, asset lists, and/or other information), receive requests to perform HCA, respond to requests with outputs such as risk indicators, and/or perform other functions.

Device 103 may be a computing device (e.g., laptop computer, desktop computer, mobile device, tablet, smartphone, server, server blade, and/or other device) and/or other data storing or computing component (e.g., processors, memories, communication interfaces, databases) that may be used to transfer information between devices and/or perform other user functions (e.g., receiving a risk indicator, receiving packet filtering rules, and/or other functions). In one or more instances, device 103 may correspond to a first user (who may, e.g., be a subscriber/customer of a CSaaS provider, such as the provider of CSaaS 104, and/or other users). For example, the device 103 may correspond to a subscriber/customer of an HCA service implemented by one or more computing devices (e.g., HCA platform 102, or the like). In one or more examples, the device 103 may be configured to communicate with one or more systems (e.g., HCA platform 102, CSaaS 104, and/or other systems) to perform a data transfer, receive a risk indicator, receive packet filtering rules, and/or other functions. In one or more instances, the device 103 may be and/or correspond to a computer system that may host one or more applications, programs, or the like configured to communicate with HCA platform 102. In these instances, the device 103 may communicate with (e.g., via the computer system and one or more applications) additional applications and/or services, such as those comprising CSaaS 104, or the like.

CSaaS 104 may be and/or include one or more computing devices (e.g., laptop computers, desktop computers, mobile devices, tablets, smartphones, or the like) and/or one or more private networks associated with a CSaaS provider offering cybersecurity protections (e.g., HCA solutions, and/or other cybersecurity protections). CSaaS 104 may be and/or interact with one or more cyber threat intelligence (CTI) providers (CTIPs) 104A. For example, an entity associated with CSaaS 104 may be a CTIP, and CSaaS 104 may comprise one or more CTI feeds generated by and/or otherwise associated with the CTIP 104A. CTI may be supplied by CTI provider organizations. CTI may comprise network threat intelligence reports and/or associated network threat indicators. The network threat indicators may be in the form of IP addresses, 5-tuples, domain names, URLs, and/or any other form. The network threat indicators may indicate hosts and/or resources that may be associated with one or more network threats and/or attacks. A CTIP may publish its CTI in the form of CTI feeds, which may comprise lists of network threat indicators and associated threat context information. A CTIP may provide access (e.g., controlled and/or secure access) to associated reports and/or other information. Subscribers to a CTIP may use (e.g., consume) the CTI feeds, reports, and/or other information.

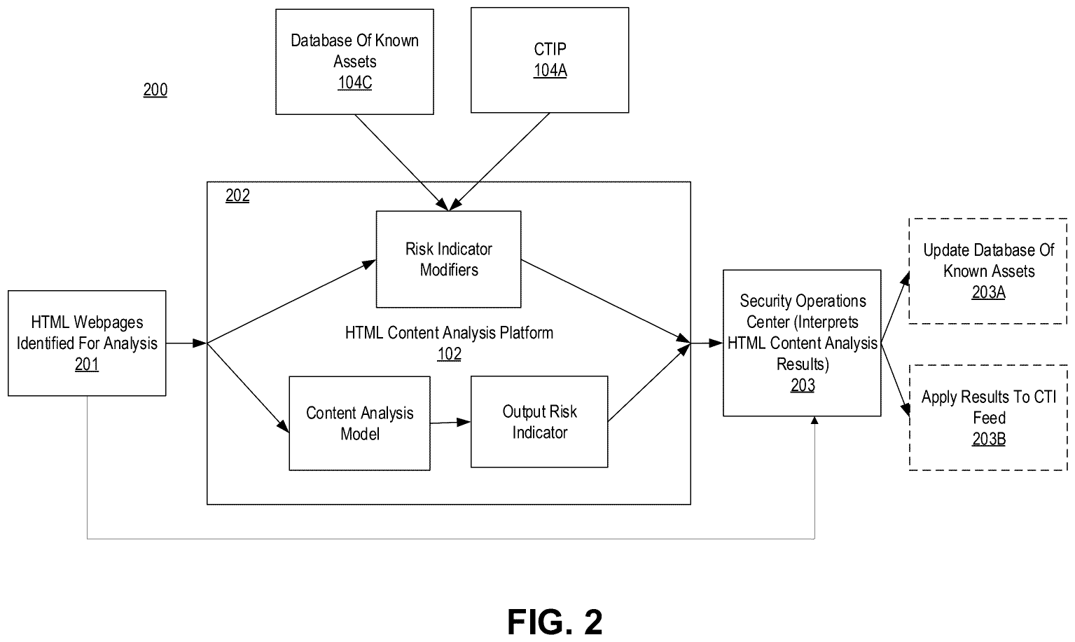

As described herein, a CSaaS 104 may operate one or more CTIP 104A services that may generate and/or otherwise publish CTI feeds that comprise one or more domain names. For example, the CTI feeds may comprise domain names detected to be homoglyphic domain names associated with malicious content (e.g., using malicious homoglyphic domain name (“MHDN”) detection processes described in U.S. Pat. No. 11,757,901, which is hereby incorporated by reference in its entirety). Subscribers to CTIP 104A services may comprise one or more Security Policy Management Server(s) SPMS(s) 104B. The SPMS(s) may use (e.g., consume) the CTI, transform the CTI into one or more rules and/or policies (e.g., sets of packet filtering rules and/or policies), and/or distribute the one or more rules and/or policies to its subscriber(s). A CSaaS 104 may operate one or more SPMS(s) 104B that may distribute the one or more rules and/or policies to one or more packet filtering devices operated by CSaaS 104. When a packet filtering device is configured with rules and/or policies that are derived from CTI and is also configured as a gateway, which is an interface between a network protected by a (CTI-derived) policy and an unprotected network, then the so-configured packet filtering device may be called a threat intelligence gateway (TIG). For example, a TIG may apply one or more CTI-derived rules and/or policies to all packet traffic traversing the boundary between the protected network and the unprotected network, for example, traversing the Internet access links that connect a (protected) private enterprise network to the (unprotected) Internet (e.g., Internet traffic sent to/from a subscriber/customer of CSaaS 104, and/or other networked users). A TIG may comprise one or more efficient index data structures comprising risk indicators for HTML webpages and the corresponding domain names of the HTML webpages. A TIG may generate one or more logs for a communication event (e.g., any communications events that match packet filtering rules in the policies). The one or more logs may be sent to a Security Operations Center (SOC) (for example, the SOC described at block 203 in FIG. 2) that may, in some examples, comprise the CSaaS 104. One or more cyberanalysts (e.g., at the SOC) may use SIEM applications to input (e.g., ingest), process, and/or analyze the log(s). The one or more cyberanalysts may determine remedial actions (e.g., based on the analyzed logs) that may further protect the (protected) network from the threats.

As described herein, CSaaS 104 may further comprise one or more databases. For example, the CSaaS 104 may comprise one or more databases of known assets 104C. A database of known assets 104C may be and/or otherwise comprise one or more computing devices (e.g., servers, server blades, laptop computers, desktop computers, mobile devices, tablets, smartphones, and/or other devices) and/or other computer components (e.g., processors, memories, communication interfaces) that may be used to create, host, modify, and/or otherwise validate an organized collection of information (e.g., a list of known malicious assets, a list of known assets included in and/or associated with one or more known malicious HTML webpages, and/or a list of known legitimate assets). A database of known assets 104C may be synchronized across multiple nodes (e.g., sites, institutions, geographical locations, and/or other nodes) and may be accessible by multiple users (who may, e.g., be employees of a cybersecurity organization such as the CSaaS provider associated with CSaaS 104). The information stored at the database of known assets 104C may include records of identified (e.g., known malicious or known legitimate) assets (e.g., network assets such as text content, graphics, photographs, video files, audio files, databases, webpages, and/or other assets). In some instances, the records may be automatically received and periodically updated with CTI (e.g., from CTIP 104A). Additionally or alternatively, in some examples, the records may be received and periodically updated manually by a user (e.g., an employee of a CSaaS provider, such as the provider of CSaaS 104). In some instances, the database of known assets 104C may be accessed by, validated by, and/or modified by HCA platform 102, a user, such as an employee of the provider of CSaaS 104, and/or other devices or users. Although only one database of known assets 104C is depicted herein, any number of such systems may be used to implement the methods described herein without departing from the scope of the disclosure.

Computing environment 100 may also include one or more networks, which may interconnect HCA platform 102, device 103, and CSaaS 104. For example, computing environment 100 may include a network 101 (which may interconnect, e.g., HCA platform 102, device 103, and CSaaS 104).

In one or more arrangements, HCA platform 102, device 103, and CSaaS 104 may be and/or include any type of computing device capable of sending and/or receiving requests and processing the requests accordingly. As noted above, and as illustrated in greater detail below, and/or all of HCA platform 102, device 103, and CSaaS 104 may be and/or include general-purpose computing devices and/or special-purpose computing devices configured to perform specific functions.

Referring to FIG. 1B, HCA platform 102 may comprise one or more computing devices that include one or more processors 111, memory 112, and communication interface 113. An information bus may interconnect processor 111, memory 112, and communication interface 113. In some examples, the information bus may be, and/or be implemented by, a network. Communication interface 113 may be a network interface configured to support communication between HCA platform 102 and one or more networks (e.g., network 101, or the like). Communication interface 113 may be communicatively coupled to the processor 111. Memory 112 may include one or more program modules having instructions that, when executed by processor 111, cause HCA platform 102 to perform one or more functions described herein, and/or one or more databases (e.g., an HTML content analysis (HCA) database 112c, or the like) that may store and/or otherwise maintain information which may be used by such program modules and/or processor 111. In some instances, the one or more program modules and/or databases may be stored by and/or maintained in different memory units of HCA platform 102 and/or by different network-connected computing devices that may form and/or otherwise make up HCA platform 102. For example, memory 112 may have, host, store, and/or include an HTML content analysis (HCA) training module 112a, an HTML content analysis (HCA) execution module 112b, an HTML content analysis (HCA) database 112c, and/or a machine learning engine 112d. HCA training module 112a may have instructions that direct and/or cause HCA platform 102 to parse HTML webpages (e.g., HTML webpages retrieved using the HTTP client of a web browser, HTML webpages retrieved from local databases of preloaded webpages, and/or other HTML webpages), extract resource identifiers, generate binary asset representation (BAR) schema, process training records, and/or perform other HCA training functions. HCA execution module 112b may have instructions that direct and/or cause HCA platform 102 to generate feature vectors, generate risk indicators, output risk indicators, generate new training records, and/or perform other HCA execution functions. HCA database 112c may have instructions causing HCA platform 102 to store training records, lists of known assets, and/or other information associated with performing HCA. Machine learning engine 112d may contain instructions causing HCA platform 102 to train, implement, and/or update one or more machine learning models, such as a content analysis model (that may, e.g., be used to generate feature vectors, such as BARs, as part of an HCA process/solution), and/or other models. In some instances, machine learning engine 112d may be used by HCA platform 102 to refine and/or otherwise update methods for performing HCA on potentially malicious HTML webpages, and/or other methods described herein.

FIG. 2 shows an example input and output system 200 for a platform configured to perform HCA in accordance with one or more example arrangements. At block 201, one or more HTML webpages may be identified for analysis (e.g., the one or more HTML webpages may be identified as candidates for HCA). For example, the one or more HTML webpages may be identified for analysis based on a corresponding domain name being included in a CTI feed and/or a threat event log. The HCA platform 102 may receive, as input, the one or more HTML webpages identified for analysis. For example, the HCA platform 102 may receive the one or more HTML webpages by retrieving the one or more HTML webpages based on their domain names which may, for example, be received by the HCA platform 102 as part of a CTI feed provided by CTIP 104A. For example, a CTI feed provided by CTIP 104A may include domain names corresponding to one or more HTML webpages identified by a cyberanalyst, a cybersecurity program, or the like, as potentially malicious HTML webpages. In some instances, the CTI feed may be received by the HCA platform 102 directly from CTIP 104A. In some examples, the CTI feed may be received by the HCA platform 102 via a CSaaS 104 (e.g., via a wired or wireless data connection established between HCA platform 102 and the CSaaS 104, and/or by other means). In some examples, the HCA platform 102 may retrieve the one or more HTML webpage by issuing, one or more requests (e.g., a GET command, or the like) from a browser's HTTP client to retrieve the one or more HTML webpages corresponding to domain names received (e.g., as part of a CTI feed or threat event log) by the HCA platform 102. In these examples, the one or more HTML webpages may be retrieved without rendering the HTML webpages in the browser. Additionally or alternatively, in some examples, the HCA platform 102 may retrieve the one or more HTML webpages by accessing the one or more HTML webpages from a local database (e.g., HTML content analysis database 112c, database of known assets 104C, and/or other databases). For example, the HCA platform 102 may retrieve the one or more HTML webpages based on an index associating the one or more HTML webpages with respective domain names and by querying the respective domain names at the local database to retrieve the corresponding HTML webpages.

The one or more HTML webpages may be received via communication interface 113 and while a data connection is established (e.g., between HCA platform 102 and a user device, such as a provider device of CSaaS 104, and/or other user devices). For example, the one or more HTML webpages may be received based on first receiving one or more domain names corresponding to the one or more HTML webpages. In these examples, the one or more HTML webpages may be received based on sending a GET request to retrieve the one or more HTML webpages via a web browser's HTTP client, querying a local database for webpages corresponding to the one or more domain names, and/or based on other methods. In some instances, in receiving the one or more HTML webpages identified for analysis, the HCA platform 102 may additionally receive one or more requests and/or instructions directing the HCA platform 102 to perform HCA on the one or more HTML webpages.

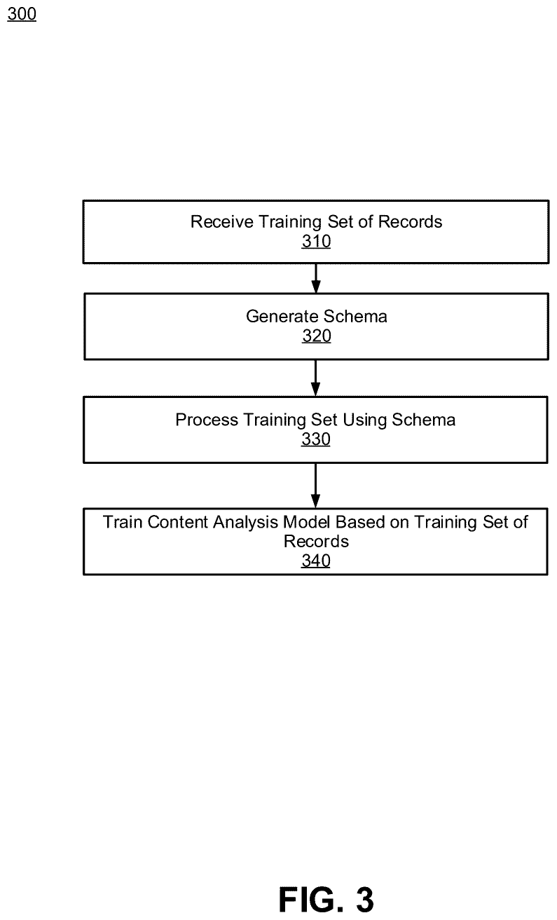

At block 202, the HCA platform 102 may, based on receiving the HTML webpages and/or the respective domain names of the HTML webpages identified for analysis as described at block 201, perform HCA techniques described herein on one or more potentially malicious HTML webpages (e.g., the HTML webpages identified for analysis). For example, HCA platform 102 may perform HCA using a content analysis model to output, for each respective potentially malicious HTML webpage, a risk indicator (a binary value or confidence score indicating the likelihood that a potentially malicious HTML webpage corresponds to a malicious HTML webpage) for the potentially malicious HTML webpage (e.g., using the steps and functions described herein with respect to FIGS. 3-8). Accordingly, based on the input of the potentially malicious HTML webpages, the HCA platform 102 may output a risk indicator for each respective potentially malicious HTML webpage. The HCA platform 102 may output risk indicators (as described above) to a SOC so that the SOC can interpret risk indicators and perform one or more cybersecurity actions (e.g., updating a database of known assets, adjusting the confidence level of a CTI feed, modifying an action associated with a CTI feed, generating a new CTI feed, and/or other actions) as described at block 203.

Additionally or alternatively, in some examples, the HCA platform 102 may receive additional inputs. For example, as illustrated at block 202, the HCA platform 102 may receive input from a database of known assets 104C. In some examples, in receiving input from the database of known assets 104C, the HCA platform 102 may receive, as input, information such as a list of known malicious assets (e.g., assets identified as malicious by a cyberanalyst associated with the CSaaS 104, assets identified as malicious using one or more automated processes provided by CSaaS 104, and/or other known malicious assets), a list of known legitimate assets (e.g., assets identified as legitimate by a cyberanalyst associated the CSaaS 104, assets identified as legitimate using one or more automated processes provided by CSaaS 104, and/or other known legitimate assets), a list of known parking assets (e.g., assets identified as parking by a cyberanalyst associated with the CSaaS 104, assets identified as parking using one or more automated processes provided by CSaaS 104, and/or other known parking assets), a list of assets included in and/or associated with one or more known malicious HTML webpages, one or more resource identifiers (e.g., names, signatures, links (e.g., URL links to webpages), and/or other methods of identifying the source and/or location of an asset) that may, e.g., each identify a known asset in a list of known malicious assets or a list of known legitimate assets or a list of known parking assets, and/or other information.

Additionally or alternatively, in some instances the HCA platform 102 may receive input from a CTIP 104A. For example, the HCA platform may receive one or more CTI feeds from CTIP 104A that may include information of known assets. For instance, in receiving the one or more CTI feeds, the HCA platform 102 may receive, as input, information such as a list of known malicious assets (e.g., assets identified as malicious by a cyberanalyst associated the CSaaS 104, assets identified as malicious using one or more automated processes provided by CSaaS 104, and/or other known malicious assets), a list of known legitimate assets (e.g., assets identified as legitimate by a cyberanalyst associated the CSaaS 104, assets identified as legitimate using one or more automated processes provided by CSaaS 104, and/or other known legitimate assets), a list of known parking assets (e.g., assets identified as parking by a cyberanalyst associated the CSaaS 104, assets identified as parking using one or more automated processes provided by CSaaS 104, and/or other known parking assets), a list of assets included in and/or associated with one or more known malicious HTML webpages, one or more resource identifiers (e.g., e.g., names, signatures, links (e.g., URL links, or the like), and/or other methods of identifying the source and/or location of an asset) that may, e.g., each identify a known asset in a list of known malicious assets or a list of known legitimate assets or a list of known parking assets, and/or other information.

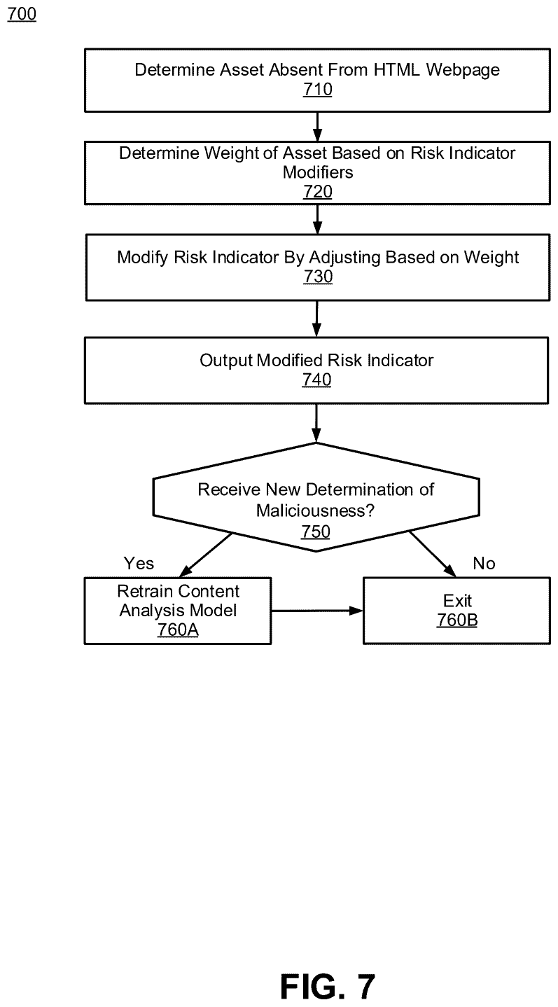

Based on receiving additional inputs (e.g., from a database of known assets 104C, from a CTIP 104A, and/or from other sources) the HCA platform 102 may perform one or more additional HCA techniques described herein. For example, the HCA platform 102 may use the additional inputs as risk indicator modifiers and modify one or more risk indicators (e.g., one or more risk indicators generated as part of an HCA process). For instance, the HCA platform 102 may modify a particular risk indicator based on determining that one or more known malicious assets are absent from a potentially malicious HTML webpage corresponding to the particular risk indicator (e.g., as described below with respect to FIG. 7). In modifying the one or more risk indicators, the HCA platform 102 may modify and/or supplement the risk indicators outputted to the SOC.

At block 203, an SOC (which may, e.g., comprise and/or be operated by CSaaS 104) may interpret HCA results and generate a responsive output. For example, the SOC may receive, as input, one or more risk indicators (and/or modified risk indicators) outputted by the HCA platform 102 (e.g., as described at block 202). In these examples, the SOC may interpret the risk indicators by, for example: comparing the one or more risk indicators to their respective corresponding potentially malicious HTML webpages (which may, e.g., have been received as inputs after being identified at block 201); and/or sandboxing a web browser that executes/renders HTML webpages, inspecting the corresponding HTML webpages using the HTTP client of the browser, determining whether the webpages are malicious or not, and comparing the determinations to the risk indicators. In some examples, in interpreting the HCA results, the SOC may identify one or more assets and/or one or more HTML webpages for updating a database of known assets. In these examples, an output 203A of the SOC at block 203 may be to cause an update to a database of known assets. For example, in identifying the one or more assets for updating a database of known assets, the SOC may, based on a risk indicator for a potentially malicious HTML webpage, identify one or more assets included in the potentially malicious HTML webpage that are not present in a list of known malicious assets or a list of known legitimate assets or a list of known parking assets. For instances, based on a risk indicator satisfying a threshold likelihood that the potentially malicious HTML webpage corresponds to a malicious HTML webpage, the SOC may compare (e.g., automatically, such as by executing one or more computer programs modules, or the like, and/or by outputting a notification causing a human cyberanalyst to compare) the assets included in the potentially malicious HTML webpage to a list of known malicious assets and a list of known legitimate assets and a list of known parking assets, which may, e.g., each be stored at a database of known assets (e.g., database of known assets 104C, and/or other databases) to identify a list of unknown assets. Based on the comparison, the SOC may cause, via an update, the list of known legitimate assets and/or the list of known malicious assets and/or the list of known parking assets to include one or more assets of the list of unknown assets. Additionally or alternatively, based on a risk indicator satisfying a threshold likelihood that the potentially malicious HTML webpage corresponds to a malicious HTML webpage, the SOC may add the assets of the potentially malicious HTML webpage to a list of known malicious assets; and/or the SOC may add the domain name corresponding to the potentially malicious HTML webpage to a data structure containing domain names corresponding to malicious HTML webpages.

Additionally or alternatively, in some examples, based on interpreting the HCA results an output 203B of the SOC at block 203 may be to cause an adjustment to a confidence level of a CTI feed. For instance, in some examples, the SOC may have received one or more domain names corresponding to one or more potentially malicious HTML webpages or potentially parked/wildcard domain HTML webpages via a CTI feed (e.g., from a CTIP, such as CTIP 104A) after the one or more potentially malicious HTML webpages or potentially parked/wildcard domain HTML webpages were identified for analysis (e.g., as described above at block 201). Based on receiving one or more risk indicators (and/or modified risk indicators) outputted by the HCA platform 102 (each of the one or more risk indicators corresponding to a respective potentially malicious HTML webpage or potentially parked/wildcard domain HTML webpage), the SOC may adjust (e.g., increase, or decrease) a confidence level (e.g., a numerical value (such as an integer value, a percentage value, a decimal value, and/or other numerical values), a grade (e.g., a letter grade, an alphanumeric grade, and/or other grades, and/or other confidence levels) of the CTI feed that provided the one or more potentially malicious HTML webpages or potentially parked/wildcard domain HTML webpages. For example, based on receiving a threshold number of risk indicators, each corresponding to a confidence score satisfying a threshold confidence score (which may, e.g., indicate a likelihood that a potentially malicious HTML webpage corresponds to a malicious HTML webpage or that a potentially parked/wildcard domain HTML webpage corresponds to a parked/wildcard domain HTML webpage), the SOC may increase the confidence level of the CTI feed that included the domain names for potentially malicious HTML webpages or potentially parked/wildcard domain HTML webpages corresponding to each risk indicator of the threshold number of risk indicators.

Additionally or alternatively, in some instances, the SOC may cause CTIP 104A to generate a new CTI feed, having a confidence level greater than the confidence level of the CTI feed that provided the domain names of the potentially malicious HTML webpages or potentially parked/wildcard domain HTML webpages corresponding to each risk indicator of the threshold number of risk indicators, and including the potentially malicious HTML webpages or potentially parked/wildcard domain HTML webpages corresponding to each risk indicator of the threshold number of risk indicators. For example, if the CTI feed that provided the domain names of the potentially malicious HTML webpages or potentially parked/wildcard domain HTML webpages corresponding to each risk indicator was associated with a low confidence level, a new CTI feed comprising the domain names of the potentially malicious HTML webpages or potentially parked/wildcard domain HTML webpages corresponding to risk indicators (exceeding a threshold level of risk) may be generated. The new CTI feed may be associated with a high confidence level.

In some instances, the adjusted CTI feed and/or the new CTI feed may be provided to an SPMS, such as SPMS 104B controlled by CSaaS 104, to cause the SPMS to use (e.g., consume) the adjusted CTI and/or the new CTI feed, transform the adjusted CTI and/or the new CTI feed into one or more rules and/or policies (e.g., sets of packet filtering rules and/or policies), and/or distribute the one or more rules and/or policies to its subscriber(s). By providing the one or more risk indicators used to generate the adjusted CTI feed and/or the new CTI feed, the HCA platform 102 may cause, via the SOC and the SPMS, creation of one or more packet-filtering rules (e.g., rules configured to block traffic associated with a potentially malicious HTML webpage or a potentially parked/wildcard domain HTML webpage, rules configured to permit traffic associated with a potentially malicious HTML webpage or a potentially parked/wildcard domain HTML webpage, and/or other rules). The one or more packet-filtering rules may be enforced by a packet-filtering device, such as a threat intelligence gateway (TIG) (e.g., RuleGATE®, and/or other TIGs).

FIG. 3 shows an example method for training a content analysis model for performing HCA in accordance with one or more example arrangements. For example, HCA training method 300 may be used to train a content analysis model to determine a likelihood that a potentially malicious HTML webpage corresponds to a malicious HTML webpage, determine a ratio of known malicious assets to known legitimate assets and/or known parking assets in a potentially malicious HTML webpage, and/or perform other HCA methods described herein. Referring to FIG. 3, at step 310, a training set of records may be received. For example, HCA platform 102 may receive a training set of records in order to train a content analysis model for performing HCA techniques described herein. In some instances, the training set of records may be received from a device associated with a CSaaS provider, such as a CSaaS 104. Additionally or alternatively, in some examples, the training set of records may be received based on a CTI feed, such as a CTI feed produced and/or maintained by CTIP 104A. For example, a CTI feed may comprise one or more domain names corresponding to HTML webpages. In these examples, the HCA platform 102 and/or other devices may retrieve the HTML webpages (e.g., by sending a request using a browser's HTTP client, by querying a database comprising preloaded HTML webpages, and/or by other methods) based on the one or more domain names. When a retrieved (parent) HTML webpage includes URL links that may redirect a browser to other HTML webpages, then in some instances the other (child) HTML webpages may be recursively retrieved by, for example, sending a request for a child HTML webpage using a browser's HTTP client. A retrieved child HTML webpage may include URL links that further redirect a browser to other HTML webpages that may be recursively retrieved. Recursive retrieval may continue until a preconfigured trigger for ending recursive retrieval is satisfied. For example, recursive retrieval may continue until a (configurable) recursion depth limit is reached. Additionally or alternatively, recursive retrieval may continue until a loop is encountered where a child HTML webpage redirects to one or more parent HTML webpages. Child HTML webpages may be incorporated into the parent HTML webpage. The training set of records may be and/or comprise domain names corresponding to HTML webpages. In some examples, the training set of records may additionally or alternatively comprise, and/or be used to derive, feature vectors corresponding to the assets of the HTML webpages retrieved by the HCA platform 102.

The training set of records may include one or more training records. Each training record in the training set of records may include a domain name corresponding to an HTML webpage and an indication (e.g., a digital flag, a notification, a tag, and/or other indications) of a previous determination as to whether the corresponding HTML webpage corresponds to a malicious HTML webpage. For example, each training record may comprise an HTML webpage (and/or a reference, such as a domain name, corresponding to the HTML webpage) that was previously analyzed by a human cyber analyst and identified as including malicious content (e.g., ransomware, software associated with botnets, reconnaissance software, links (e.g., URL links that may redirect a web browser to a known malicious HTML webpage), and/or other malicious content). Additionally or alternatively, in some instances, each training record may comprise an HTML webpage (and/or a reference, such as a domain name, corresponding to the HTML webpage) that was previously analyzed (e.g., by a human cyberanalyst and/or by a machine cyberanalyst) and identified as a legitimate HTML webpage (e.g., an HTML webpage free of malicious content, or an HTML webpage that does not exceed a threshold amount of malicious content).

Additionally or alternatively, in some instances, each training record may comprise an HTML webpage (and/or a reference, such as a domain name, corresponding to the HTML webpage) that was previously analyzed (e.g., by a human cyberanalyst and/or by a machine cyberanalyst) and identified as a parked/wildcard domain HTML webpage. For example, each training record may comprise an HTML webpage that includes parking content and/or assets and free of malicious content, and/or an HTML webpage comprising parking content and/or assets and that does not exceed a threshold amount of malicious content. The parking content and/or assets may be and/or include assets corresponding to a threshold likelihood of being found on a parked/wildcard domain HTML webpage. For example, parking content and/or assets may comprise URL links that redirect to a legitimate HTML webpage but which, cumulatively, indicate an HTML webpage comprising the parking content and/or assets exceeds a threshold likelihood of being a parked/wildcard domain HTML webpage. In a specific example, an HTML webpage may comprise a minimum number and/or type of assets required to display a functional webpage, such as a number of assets corresponding to style sheets (e.g., a URL link to a free style sheet webpage, such as fct[.]co), a number of assets corresponding to a host of the HTML webpage (e.g., a link to facebook[.]com, or the like). In these examples, the HTML webpage may lack additional, diverse, assets such as advertising or video assets. Accordingly, the combination of the lack of diverse assets with the presence of a number of assets associated with parked/wildcard domain HTML webpages (e.g., the minimum number and/or type of assets required to display a functional webpage, as described herein) may satisfy the threshold likelihood of an HTML webpage being a parked/wildcard domain HTML webpage. In some examples, each training record may further include an indication (e.g., a digital flag, a notification, a tag, and/or other indications) of whether the corresponding HTML webpage was identified as malicious or legitimate or parking. Each HTML webpage corresponding to the domain names included in the training set may include resource identifiers (names, signatures, links (e.g., URL links, or the like), and/or other methods of identifying the source and/or location of an asset) and/or other references to a plurality of assets (e.g., network assets such as text content, graphics, photographs, video files, audio files, databases, webpages, and/or other assets). The resource identifiers may be embedded in the HTML source code of each respective HTML webpage.

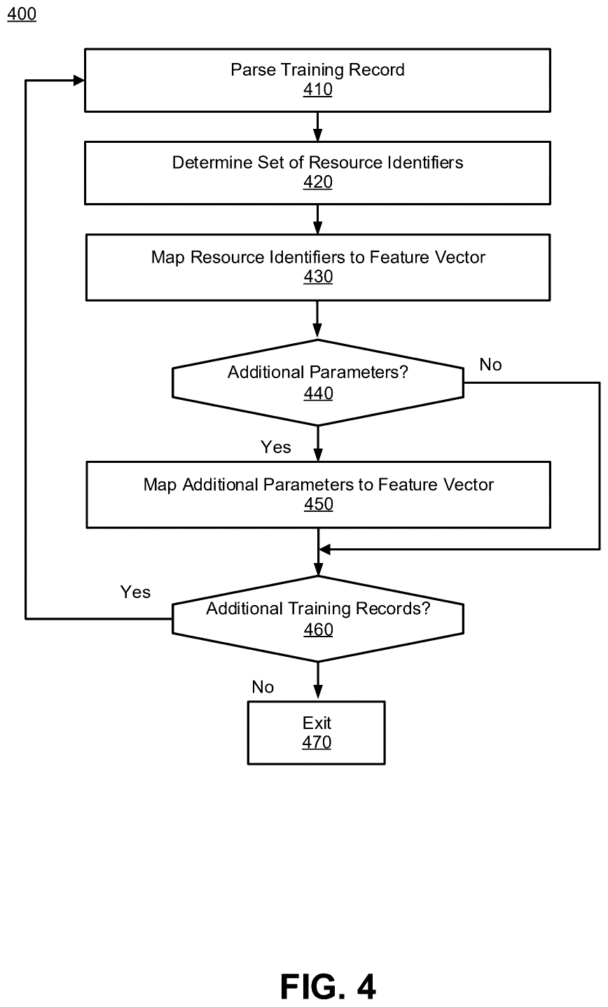

At step 320, a schema for generating feature vectors, such as a binary asset representation (BAR) schema, may be generated for the training set of records. For example, HCA platform 102 may generate a BAR schema corresponding to all of the assets referenced in and/or otherwise corresponding to the training set, in order to train a content analysis model. For instance, the HCA platform 102 may generate a BAR schema that provides a mapping, for each resource identifier included in a given HTML webpage and/or a plurality of HTML webpages, to a position in a BAR. The schema may be used to process training records and potentially malicious HTML webpages as part of HCA techniques described herein (e.g., as described in further detail below with respect to FIGS. 4-8). In generating the feature vector (e.g., BAR) schema, the HCA platform 102 may parse each HTML webpage corresponding to domain names included in the training set of records to identify the resource identifiers included in each HTML webpage. For example, the HCA platform 102 may parse each HTML webpage by extracting, from a given HTML webpage, the resource identifiers of each asset referenced in the HTML webpage and generating a set of resource identifiers that includes some or all of the extracted resource identifiers. The HCA platform 102 may then generate the BAR schema such that the schema includes steps and/or instructions directing computing devices (such as HCA platform 102, and/or other computing devices) to map each position in a BAR (and/or other feature vectors) of a given HTML webpage to a corresponding resource identifier from the set of resource identifiers. FIG. 4 shows an example method for performing the steps of generating a schema to perform HCA described herein, in accordance with one or more example arrangements.

Referring to FIG. 4, a schema generation method 400 may be used to generate a schema. For example, HCA platform 102 may implement schema generation method 400 to generate a feature vector (e.g., BAR) schema for use in HCA techniques described herein. Although FIG. 4 is described below in an example where the schema is a BAR schema, it should be understood that alternative feature vector schemas may be generated without departing from the scope of this disclosure. At step 410, a training record including a domain name for an HTML webpage may be parsed. For example, a computing device such as HCA platform 102 may retrieve the HTML webpage corresponding to the domain name (e.g., by using a request, such as a GET request, implemented by a web browser's HTTP client, by querying the domain name at a database comprising preloaded HTML webpages, and/or by other methods). Similar to step 310 above, when a retrieved (parent) HTML webpage includes URL links that may redirect a browser to other HTML webpages, then in some instances the other (child) HTML webpages may be recursively retrieved by, for example, sending a request for a child HTML webpage using a browser's HTTP client. Child HTML webpages may be incorporated into the parent HTML webpage. Also similar to step 310 above, a retrieved child HTML webpage may include URL links that further redirect a browser to other HTML webpages that may be recursively retrieved. Recursive retrieval may continue until a preconfigured trigger for ending recursive retrieval is satisfied. For example, recursive retrieval may continue until a (configurable) recursion depth limit is reached. Additionally or alternatively, recursive retrieval may continue until a loop is encountered where a child HTML webpage redirects to one or more parent HTML webpages The HCA platform 102 may read, mine, and/or otherwise parse the HTML code included in the retrieved HTML webpage and extract each resource identifier included in the HTML code (e.g., by creating a copy (e.g., in a file, and/or by other means) of each resource identifier, by calling an application program interface (API) to extract each resource identifier, and/or by other methods of extracting resource identifiers). In some examples, the HCA platform 102 may parse the HTML webpage by retrieving the HTML code via a link (e.g., a URL link to a website corresponding to a domain name and hosted by a web server connected to a network) and/or other reference to the HTML webpage. For instance, HCA platform 102 may, based on a link and/or other reference to the HTML webpage, use web scraping to extract the underlying HTML code of the HTML webpage and may replicate the code in internal memory (e.g., memory 112, and/or other memory) of the HCA platform 102. The HCA platform 102 may extract the resource identifiers from the replicated HTML code without ever executing HTML (e.g., without causing the HTML webpage to be displayed on a web browser or otherwise rendered by a web browser).

At step 420, a set of resource identifiers may be determined. For example, HCA platform 102 may determine the set of resource identifiers based on the resource identifiers of each asset referenced in the HTML webpage and extracted by parsing the HTML webpage of the domain name included in the training record. In some instances, in determining the set of resource identifiers, the HCA platform 102 may determine the set of resource identifiers comprises all of the resource identifiers extracted from the HTML webpage (e.g., as described above at step 410). In some examples, the HCA platform 102, in determining the set of resource identifiers, may refine and/or otherwise modify the set of resource identifiers including all of the resource identifiers extracted from the HTML webpage by parsing the set of resource identifiers. For example, the HCA platform 102 may parse the set of resource identifiers by comparing each resource identifier in the set to determine whether there are any duplicate resource identifiers (e.g., identical duplicate resource identifiers, alias duplicate resource identifiers, common domain name subpart resource identifiers, and/or other duplicate resource identifiers) included in the set of resource identifiers.

In some examples, duplicate resource identifiers may be identical. For instance, a first resource identifier may be a URL such as “http://unknown.com/,” and a second resource identifier may be the same URL “http://unknown.com” (e.g., in instances where an HTML webpage included two separate links to the website associated with unknown.com, and/or other scenarios). Based on determining that there are one or more identical resource identifiers in the set of resource identifiers, the HCA platform 102 may remove identical resource identifiers from the set of resource identifiers until only one resource identifier, of the identical resource identifiers, remains. For instance, if the HCA platform 102 determines there are three identical resource identifiers all with the same URL “http://unknown.com/,” two of the identical resource identifiers may be removed but one of the identical resource identifiers may be retained.

Additionally or alternatively, in some instances, duplicate resource identifiers may share a common/same domain name subpart (e.g., a subdomain, a second-level domain, and/or other domain name subparts). For example, a first resource identifier may be “unknown.com” and a second resource identifier may be “unknown.co,” sharing a common/same domain name subpart “unknown”. In some instances, duplicate resource identifiers may share a common/same domain name subpart but differ in a second domain name subpart. For example, a first resource identifier may be “page1.unknown.com” and a second resource identifier may be “page2.unknown.com.” Based on determining that there are one or more resource identifiers sharing a common/same domain name subpart in the set of resource identifiers, the HCA platform 102 may include and/or continue to include the one or more resource identifiers sharing a common/same domain name subpart in the set of resource identifiers, but may map the one or more resource identifiers sharing a common/same domain name subpart to the same position in a BAR of the HTML webpage (e.g., as described below at step 403).

Additionally or alternatively, in some examples, duplicate resource identifiers may be aliases of one of the resource identifiers. For example, a first resource identifier such as “unknown.com” and a second resource identifier such as “maliciousguy.com” may both reference the same asset (e.g., a webpage, and/or other assets). For instance, a query (such as an HTTP GET method request, or the like) for the webpage corresponding to “unknown.com” may return the same webpage as a query for the webpage corresponding to “maliciousguy.com,” when used as input for a web browser. The HCA platform 102 may determine a resource identifier is an alias of another resource identifier included in the set of resource identifiers based on comparing each resource identifier in the set of resource identifiers to a watchlist (which may, e.g., be included in a CTI feed received by HCA platform 102 from a CTIP 104A) of known alias resources. For example, the watchlist may be and/or comprise a list of well-known/popular domain names and their associated alias domain names. Based on determining that there are one or more alias resource identifiers in the set of resource identifiers, the HCA platform 102 may include and/or continue to include the one or more alias identifiers in the set of resource identifiers, but may map the one or more alias resource identifiers to the same position in a BAR of the HTML webpage (e.g., as described below at step 403).

Based on determining the set of resource identifiers to be used in the BAR schema, the HCA platform 102 may generate the set of resource identifiers (e.g., by including and/or removing resource identifiers as described above).

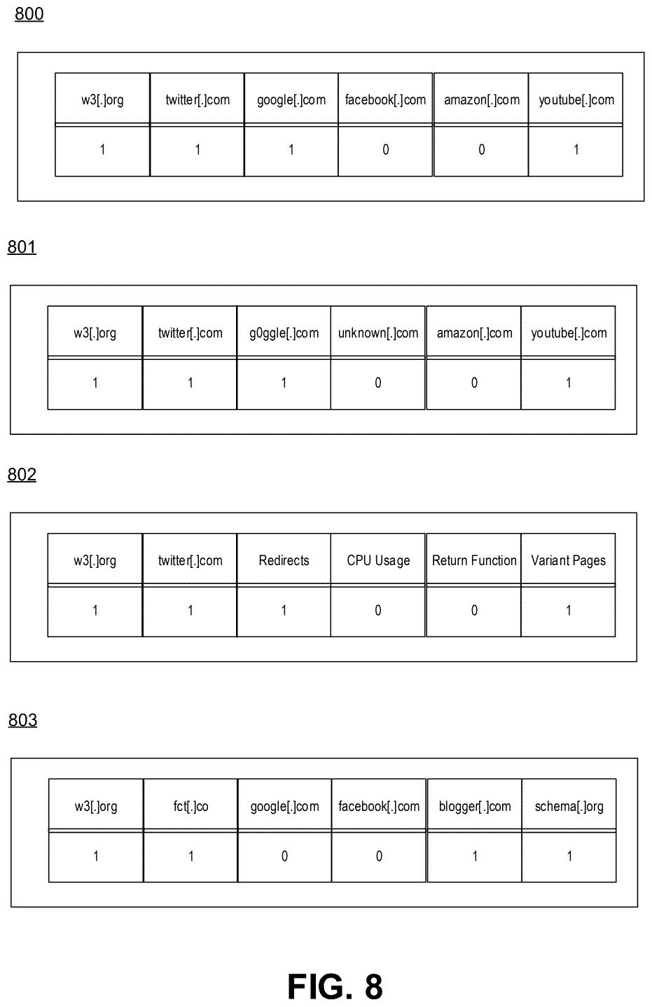

At step 430, as part of generating the BAR schema, the set of resource identifiers may be mapped to positions in a feature vector, such as a BAR. For example, the HCA platform 102 may generate a BAR schema configured to identify, designate, assign, and/or otherwise map each resource identifier of the set of resource identifiers to a particular position in any BARs of the HTML webpage generated using the BAR schema. A BAR may be and/or include a string of binary bits indicating, at each position (i.e., at each bit in the string) the presence (e.g., with a binary bit of “1”) or the absence (e.g., with a binary bit of “0”) of a resource identifier in an HTML webpage. FIG. 8 shows examples of feature vectors (e.g., BARs) that may be generated during HCA using a BAR schema as described above. For example, referring to FIG. 8, a BAR corresponding to a known legitimate webpage may be similar to legitimate webpage BAR 800. A legitimate webpage BAR 800 (and/or other BARs) may be and/or include a string of binary bits indicating the presence or absence of a resource identifier mapped to a corresponding position of legitimate webpage BAR 800 using a BAR schema as described above with respect to FIGS. 3 and 4. For example, as illustrated in FIG. 8, a BAR schema may have mapped “w3[.]org” to a first position in a BAR corresponding to a known legitimate webpage, “twitter[.]com” to a second position in the BAR corresponding to a known legitimate webpage, “google[.]com” to a third position in the BAR corresponding to a known legitimate webpage, and additional resource identifiers to subsequent positions in the BAR corresponding to a known legitimate webpage. In this example, the BAR schema described above may have been used to generate legitimate webpage BAR 800. It should be understood that legitimate webpage BAR 800 is merely an example BAR, and other BARs generated by and/or during HCA techniques described herein (e.g., malicious webpage BAR 801, additional parameters BAR 802, and/or other BARs) may include any number of positions of binary bits corresponding to any number of different resource identifiers. Additionally, it should be understood that the list of resource identifiers shown in legitimate webpage BAR 800 is similarly an example, and that other BARs generated by and/or during HCA techniques described herein may not include such a list and may, e.g., be a simple binary string.

Referring again to FIG. 4, at step 440, as part of generating the BAR schema, HCA platform 102 (and/or other computing devices performing HCA) may determine whether to include any additional parameters in the BAR schema. For example, in determining whether to include any additional parameters in the BAR schema, the HCA platform 102 may identify whether CSaaS 104 has provided (e.g., via user input and/or via one or more commands from a device associated with CSaaS 104) instructions and/or rules directing the HCA platform 102 to include additional parameters in the BAR schema. Based on determining that there are additional parameters to include in the BAR schema, the additional parameters may be mapped to positions in the BAR for the HTML webpage (e.g., as described below at step 450). Based on determining that there are not additional parameters to include in the BAR schema, HCA platform 102 (and/or other computing devices performing HCA) may determine whether there are any additional training records to parse (e.g., as described below at step 460) without mapping additional parameters to positions in the BAR for the HTML webpage.

At step 450, based on determining that there are additional parameters to include in the BAR schema and as part of generating the BAR schema, the HCA platform 102 may map one or more positions in the BAR for the HTML webpage to additional parameters (e.g., a number of webpage redirects associated with a request to access the HTML webpage, a percentage of central processing unit (CPU) usage of a computing device receiving a request to access the HTML webpage, a number of return functions a request to access the HTML webpage causes a web browser to execute, a number of variant webpages associated with the HTML webpage, and/or other parameters) that may be used to determine a likelihood that a potentially malicious HTML webpage corresponds to a malicious HTML webpage. The HCA platform 102 may, for example, generate a BAR schema mapping a position in the BAR for the HTML webpage to indicate whether a threshold number of webpage redirects are executed when a web browser requests access to the HTML webpage (e.g., via a URL link, and/or by other methods). The threshold number of webpage redirects may be determined and/or otherwise supplied to the HCA platform 102 by a user (e.g., a cyberanalyst associated with CSaaS 104), by a machine cyberanalyst, and/or by other sources.

Additionally or alternatively, in some examples, HCA platform 102 may generate a BAR schema mapping a position in the BAR to indicate whether the percentage of CPU processing power that is used when a computing device (e.g., device 103, and/or other devices) satisfies a request to access the HTML webpage satisfies a threshold value. For example, in some instances, a malicious HTML webpage may cause a computing device to execute functions that require additional processing power (e.g., mining cryptocurrency, executing a malicious program, and/or other functions) based on the device satisfying the request to access the HTML webpage. Accordingly, in some examples, it may be important to map, in the BAR, an indication of whether the percentage of CPU processing power that is used when a computing device (e.g., device 103, and/or other devices) satisfies a request to access the HTML webpage satisfies a threshold value. For example, the BAR schema may map a position in the BAR to include a binary value of “1” if the CPU usage meets or exceeds the threshold value when the computing device receives a request to access the HTML webpage. The threshold value may be determined and/or otherwise supplied to the HCA platform 102 by a user (e.g., a cyberanalyst associated with CSaaS 104) and/or by other sources.

Additionally or alternatively, in some instances, HCA platform 102 may generate a BAR schema mapping a position in the BAR to indicate whether a number of return functions, which would be executed in response to a request (e.g., from a device such as device 103, and/or other devices) to access the HTML webpage, satisfies a threshold number of return functions. For example, the BAR schema may map a position in the BAR to include a binary value of “1” if the number of return functions executed in response to a request to access the HTML webpage meets or exceeds the threshold number of return functions. The threshold number of return functions may be determined and/or otherwise supplied to the HCA platform 102 by a user (e.g., a cyberanalyst associated with CSaaS 104), by machine cyberanalyst, and/or by other sources.

Additionally or alternatively, in some examples, the HCA platform 102 may generate a BAR schema mapping a position in the BAR to indicate whether a number of variant webpages associated with the HTML webpage satisfies a threshold number of variant webpages. For example, the BAR schema may map a position in the BAR to include a binary value of “1” if the number of variant webpages associated with the HTML webpage meets or exceeds the threshold number of variant webpages. A variant webpage may be an HTML webpage that is displayed based on a request to display a first HTML webpage in scenarios where the user and/or the device (e.g., device 103) requesting the first HTML webpage satisfies a particular criteria. For example, a variant webpage may be displayed in response to a request to display a first HTML webpage based on one or more of: a geographic location of the device requesting display of the first HTML webpage, an internet protocol (IP) address associated with the device requesting display of the first HTML webpage, a user profile associated with the user of the device requesting display of the first HTML webpage, and/or other criteria. The threshold number of return functions may be determined and/or otherwise supplied to the HCA platform 102 by a user (e.g., a cyberanalyst associated with CSaaS 104), by a machine cyberanalyst, and/or by other sources.

In mapping the one or more positions in the BAR for the HTML webpage to additional parameters, the HCA platform 102 may determine the HTML webpage comprises information of the additional parameters based on analyzing the HTML webpage in a sandboxing mode. The HCA platform 102 may map the one or more positions in the BAR for the HTML webpage to additional parameters using the BAR schema. The BAR schema may cause BARs generated using the BAR schema to include binary bits corresponding to the mappings described above and/or to other mappings. For example, referring to FIG. 8, an example of a BAR generated using a BAR schema mapping additional parameters to positions in the BAR may be similar to additional parameters BAR 802. An additional parameters BAR 802 (and/or other BARs) may be and/or include a string of binary bits indicating the presence or absence of a resource identifier mapped to a corresponding position of additional parameters BAR 802 using a BAR schema as described above with respect to FIGS. 3 and 4. For example, as illustrated in FIG. 8, a BAR schema may have mapped “w3[.]org” to a first position in a BAR, “twitter[.]com” to a second position in the BAR, and additional resource identifiers to subsequent positions in the BAR. Additionally, an additional parameters BAR 802 (and/or other BARs) may be and/or include a string of binary bits indicating the presence or absence of an additional parameter mapped to a corresponding position of additional parameters BAR 802 using a BAR schema as described above with respect to step 450 of FIG. 4. It should be understood that additional parameters BAR 802 is merely an example BAR, and other BARs generated by and/or during HCA techniques described herein may include any number of positions of binary bits corresponding to any number of different resource identifiers and/or to any number of additional parameters. Additionally, it should be understood that the list of resource identifiers and additional parameters shown in additional parameters BAR 802 is similarly an example, and that other BARs generated by and/or during HCA techniques described herein may not include such a list and may, e.g., be a simple binary string.

Referring again to FIG. 4, at step 460, based on mapping the additional parameters to the BAR for the HTML webpage and/or based on determining there are no additional parameters to include in the BAR for the HTML webpage, HCA platform 102 (and/or other computing devices performing HCA) may determine whether there are any additional training records to parse. For example, the HCA platform 102 may determine whether every training record, of the training set of records received by the HCA platform 102 (e.g., as described above at step 310 of FIG. 3) has been parsed for resource identifiers to map to a BAR. Based on determining that there are additional training records to parse, the HCA platform 102 may continue to parse the additional training records using the method described above with respect to steps 410-450. Based on determining that all the training records, of the training set of records received by the HCA platform 102, have been parsed, the HCA platform 102 may determine that the BAR schema has been completely generated and, therefore, that the method may exit/end (470).

Referring again to FIG. 3 and HCA training method 300, at step 330, based on generating the BAR schema as described above with respect to step 320 and FIG. 4, the training set of records may be processed. For example, the HCA platform 102 may process the training set of records by parsing each training record (e.g., by extracting the resource identifiers of each asset referenced in each respective HTML webpage corresponding to domain names included in the training set of records and determining the set of resource identifiers for each respective HTML webpage). In these examples, the HCA platform 102 may parse each training record using the methods described above with respect to steps 410-420.

In processing the training set of records, a BAR may be generated for each corresponding HTML webpage for each respective domain name included in a training record, of the set of training records. For example, the HCA platform 102 may generate a BAR for each HTML webpage by using the schema (e.g., a BAR schema) generated at step 320 (e.g., as described further above at steps 410-470). The HCA platform 102 may generate the BAR for a given HTML webpage by assigning a binary bit (e.g., a “1” or a “0”) to each position in a BAR based on whether the resource identifier mapped to a corresponding position is included in the set of resource identifiers for the HTML webpage or based on whether the additional parameter mapped to a corresponding position is present in the HTML webpage. Accordingly, the HCA platform 102 may generate a BAR for each respective HTML webpage by using the BAR schema to determine whether the respective HTML webpage includes a resource identifier corresponding to the resource identifier mapped to each respective position in the BAR and assigning a binary value to each position of the BAR for each respective training record.

In some examples, a training record may include a known legitimate HTML webpage. In these examples, a BAR may be generated for the known legitimate HTML webpage that indicates the known legitimate HTML webpage includes only known legitimate assets. For example, a legitimate webpage BAR, similar to legitimate webpage BAR 800 (illustrated at FIG. 8 and as described above) may be generated. Additionally or alternatively, in some instances, a training record may include a known parked/wildcard domain HTML webpage. In these instances, a BAR may be generated for the known parked/wildcard domain HTML webpage that indicates the known parked/wildcard domain HTML webpage includes assets associated with the known parked/wildcard domain HTML webpage. For example, a parked/wildcard domain webpage BAR 803 (illustrated at FIG. 8 and as described herein) may be generated. Additionally or alternatively, in some instances, a training record may include a known malicious HTML webpage. In these instances, a BAR may be generated for the known malicious HTML webpage that indicates the known malicious HTML webpage includes assets associated with the known malicious HTML webpage. For example, a malicious webpage BAR similar to malicious webpage BAR 801, illustrated at FIG. 8, may be generated.

Referring to FIG. 8, an example of a BAR generated using a BAR schema on a known malicious HTML webpage may be similar to malicious webpage BAR 801. A malicious webpage BAR 801 (and/or other BARs) may be and/or include a string of binary bits indicating the presence or absence of a resource identifier mapped to a corresponding position of a BAR (e.g., additional parameters BAR 802) using a BAR schema as described above with respect to FIGS. 3 and 4 and/or the presence or absence of a resource identifier associated with a malicious HTML webpage. For example, as illustrated in FIG. 8, a BAR schema may have mapped known legitimate resource identifier “w3[.]org” to a first position in a BAR corresponding to a known malicious webpage, known legitimate resource identifier “twitter[.]com” to a second position in the BAR corresponding to a known malicious webpage, known malicious resource identifier “gOggle[.]com” to a third position in the BAR corresponding to a known malicious web, and additional known legitimate/known malicious resource identifiers to subsequent positions in the BAR corresponding to a known malicious webpage.

Another example of a BAR generated using a BAR schema may be similar to parked/wildcard domain webpage BAR 803. A parked/wildcard domain webpage BAR 803 may be and/or include a string of binary bits indicating the presence or absence of a resource identifier mapped to a corresponding position of a BAR using a BAR schema as described above with respect to FIGS. 3 and 4. For example, a BAR schema may have mapped positions of a BAR to resource identifiers corresponding to parked/wildcard content and/or assets, such as URL links to webpages included in known parked/wildcard domain HTML webpages. In some examples, the parked/wildcard content and/or assets may be and/or include known legitimate resource identifiers that correspond to a threshold likelihood of being included in a known parked/wildcard domain HTML webpage. For example, a set of known parked/wildcard domain HTML webpages may be included in a training set as described herein and may, in some examples, comprise one or more assets that are included in a threshold number of known parked/wildcard domain HTML webpages in the set. For example, in a set of 10 known parked/wildcard domain HTML webpages, assets such as w3[.]org, fct[.]co, blogger[.]com, and schema[.]org may each appear in at least 6 of the 10 known parked/wildcard domain HTML webpages. Accordingly, the BAR schema may have mapped positions of a BAR to resource identifiers corresponding to these assets. For example, as illustrated in FIG. 8, a BAR schema may have mapped a known legitimate asset “w3[ ]org” to a first position in the BAR corresponding to a known parked/wildcard domain HTML webpage based on “w3[ ]org” appearing in at least 6 of the 10 known parked/wildcard domain HTML webpages in a training set. Other parked/wildcard domain content and/or assets, such as “fct[.]co”, “blogger[.]com”, “schema[.]org”, or the like may similarly respectively be mapped to a second, fifth, and sixth position of a BAR corresponding to a known parked/wildcard domain HTML webpage based on appearing in a threshold number (e.g., 6 out of 10, in the example above) of known parked/wildcard domain HTML webpages in the training set.

It should be understood that malicious webpage BAR 801 and parked/wildcard domain webpage BAR 803 are merely examples of feature vectors (e.g., BARs), and other feature vectors generated by and/or during HCA techniques described herein may include any number of positions of binary bits corresponding to any number of different resource identifiers and/or to any number of additional parameters. Additionally, it should be understood that the list of resource identifiers shown in malicious webpage BAR 801 and/or in parked/wildcard domain webpage BAR 803 is similarly an example, and that other BARs generated by and/or during HCA techniques described herein may not include such a list and may, e.g., be a simple binary string.

Referring again to FIG. 3, at step 330, in some examples a BAR may be generated for a known legitimate HTML webpage and/or a known parked/wildcard domain HTML webpage and/or a known malicious HTML webpage that indicates whether the known malicious/known legitimate/known parked/wildcard domain HTML webpage includes an additional parameter. For example, a BAR containing additional parameters similar to additional parameters BAR 802 (depicted in FIG. 8 and as described above) may be generated.

At step 340, a content analysis model may be trained based on the training set of records. For example, HCA platform 102 may train a machine learning model to serve as the content analysis model. In some instances, the HCA platform 102 may train the content analysis model using the BAR for each respective HTML webpage corresponding to the domain names included in the training set of records and the corresponding indication of a cyberanalyst's determination as to whether the corresponding HTML webpage corresponds to a malicious HTML webpage as training input. Training the content analysis model may configure the content analysis model to output risk indicators based on input of BARs for potentially malicious HTML webpages.

In some instances, to configure and/or otherwise train the content analysis model, the HCA platform 102 may process the BAR for each respective HTML webpage and the corresponding indication of a determination as to whether the corresponding HTML webpage corresponds to a malicious HTML webpage by applying natural language processing, natural language understanding, supervised machine learning techniques (e.g., regression, classification, neural networks, support vector machines, random forest models, naïve Bayesian models, and/or other supervised techniques), unsupervised machine learning techniques (e.g., principal component analysis, hierarchical clustering, K-means clustering, and/or other unsupervised techniques), and/or other techniques. In doing so, the HCA platform 102 may train the content analysis model to output risk indicators based on input BARs for potentially malicious HTML webpages.

For example, in configuring and/or otherwise training the content analysis model, the HCA platform 102 may identify one or more correlations between assets included in one or more BARs of HTML webpages and the determination as to whether the corresponding HTML webpage corresponds to a malicious HTML webpage. For instance, the HCA platform 102 may determine, based on comparing the BARs for each respective HTML webpage and the corresponding indication of a determination as to whether the corresponding HTML webpage corresponds to a malicious HTML webpage, that a particular resource identifier (e.g., “unknown.com”) corresponding to an asset is included in the BARs for each respective HTML webpage that corresponds to an indication that a determination was made (e.g., by a human cyberanalyst and/or by a machine cyberanalyst) that the respective HTML webpage corresponds to a malicious HTML webpage. Accordingly, the HCA platform 102 may identify a correlation between “unknown.com” and indications that an HTML webpage corresponds to a malicious HTML webpage. Therefore, the HCA platform 102 may train the content analysis model to output a risk indicator indicating a non-zero likelihood that a potentially malicious HTML webpage with a BAR indicating the potentially malicious HTML webpage includes “unknown.com” corresponds to a malicious HTML webpage. For example, the HCA platform 102 may train the content analysis model to output the risk indicator as a confidence score indicating a percentage likelihood that the potentially malicious HTML webpage corresponds to a malicious HTML webpage (e.g., 5%, 10%, 80%, and/or other percentages). The amount by which the presence of “unknown.com” affects the likelihood that the potentially malicious HTML webpage corresponds to a malicious HTML webpage may be based on a predetermined rule (e.g., a rule from CSaaS 104) and/or based on a strength of the correlation identified by the HCA platform 102.

For example, consider the following scenario: The HCA platform 102 determines that three HTML webpages corresponding to domain names of the training set of records correspond to BARs indicating the HTML webpages include “unknown.com,” and that the three HTML webpages each were determined to be malicious, resulting in the HCA platform 102 training the content analysis model to output a confidence score indicating, e.g., a 3% likelihood that potentially malicious HTML webpages including “unknown.com” correspond to a malicious HTML webpage. Based on HCA platform 102 further determining that thirty HTML webpages corresponding to domain names of the training set of records correspond to BARs indicating the HTML webpages include “unknown.com,” and that the thirty HTML webpages each were determined to be malicious, the HCA platform 102 may train the content analysis model to instead output a confidence score indicating, e.g., a 30% likelihood that potentially malicious HTML webpages including “unknown.com” are malicious.

In configuring and/or otherwise training the content analysis model, the HCA platform 102 may identify one or more correlations between assets included in one or more BARs of HTML webpages and the determination as to whether the corresponding HTML webpage corresponds to a malicious HTML webpage in a manner similar to the above example. Additionally or alternatively, in configuring and/or otherwise training the content analysis model, the HCA platform 102 may identify one or more correlations between additional parameters included in one or more BARs of HTML webpages and the determination as to whether the corresponding HTML webpage corresponds to a malicious HTML webpage in a manner similar to the above example. It should be understood that the above examples are merely some of the many ways in which the HCA platform 102 may identify correlations and/or train the content analysis model based on identified correlations.

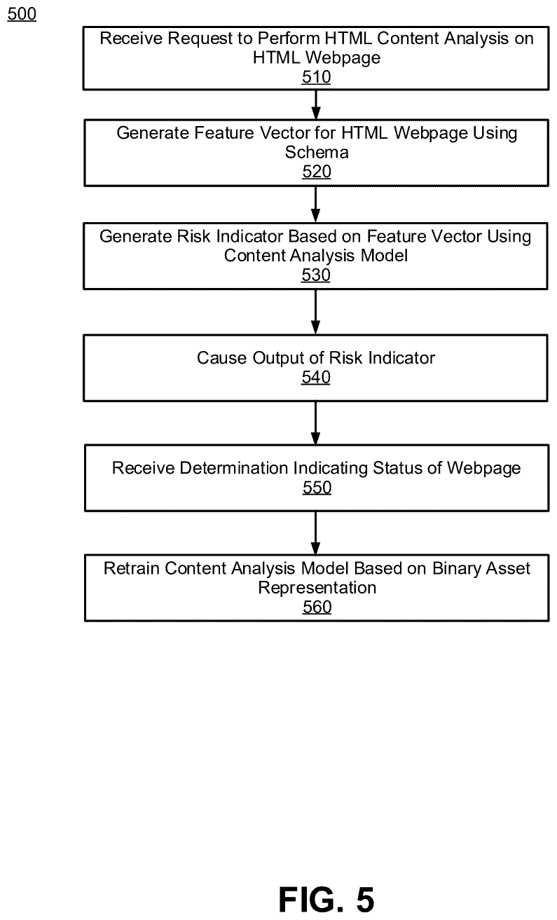

Once a content analysis model has been trained, HCA techniques described herein may be performed on potentially malicious HTML webpages by using the content analysis model. FIG. 5 shows an example method for performing HCA on a potentially malicious HTML webpage in accordance with one or more example arrangements. Although FIG. 5 is described herein as performing HCA on a potentially malicious HTML webpage, it should be understood that this is merely an example of performing HCA on a potentially malicious HTML webpage and that HCA may be performed in a similar manner on other types of HTML webpages, such as potentially parked/wildcard domain HTML webpages. Referring to FIG. 5, at step 510, the first step in an example HCA execution method 500 may be receiving a request to perform HCA on an HTML webpage. The HTML webpage may be a potentially malicious HTML webpage, indicating that the HTML webpage may be malicious or legitimate, and/or the HTML webpage may be a potentially parked/wildcard domain HTML webpage, indicating that the HTML webpage may correspond to a parked/wildcard domain name. For example, HCA platform 102 may receive a request to perform HCA on a potentially malicious HTML webpage, from one or more sources, and in the form of a domain name corresponding to the potentially malicious HTML webpage. In some examples, the request may be based on one or more indications that a potentially malicious HTML webpage should be analyzed using HCA. The one or more indications may be and/or comprise: the presence of a domain name corresponding to an HTML webpage in a watchlist of potentially malicious domain names, the presence of a domain name, corresponding to an HTML webpage, in a CTI feed, the presence of a domain name, corresponding to an HTML webpage, in a threat event log, and/or other indications.

In some instances, in receiving the request to perform HCA on a potentially malicious HTML webpage, the HCA platform 102 may receive a watchlist of potentially malicious domain names corresponding to HTML webpages. For example, the HCA platform 102 may receive the watchlist from CSaaS 104 via a computing device and/or from a CTI feed (e.g., a CTI feed created and/or maintained by CTIP 104A, or the like). The watchlist may be and/or include a list of domain names identified as corresponding to potentially malicious HTML webpages. The watchlist may have been generated by a provider of CSaaS 104 and/or CTIP 104A as part of and/or during one or more cybersecurity operations (e.g., cyberanalyst evaluations of potentially malicious HTML webpages, potentially malicious domain name detection operations, potentially malicious domain name generation operations, and/or other cybersecurity operations). In some instances, the HCA platform 102 may additionally receive one or more instructions/commands requesting the HCA platform 102 to perform HCA operations on the respective HTML webpages corresponding to each potentially malicious domain name on the watchlist.

Additionally or alternatively, in some examples, based on receiving the watchlist of potentially malicious domain names corresponding to HTML webpages, the HCA platform 102 may monitor network traffic. For example, the HCA platform 102 may monitor traffic of the network 101 (e.g., data packets sent and received via the network 101). The HCA platform 102 may monitor the network traffic via the communication interface 113 and while a data connection is established. In monitoring the network traffic, the HCA platform 102 may monitor traffic to/from one or more user devices of clients/subscribers to CSaaS 104 (e.g., device 103, and/or other user devices) and/or traffic to/from one or more computing devices operated by employees of the provider of CSaaS 104. In some examples, in monitoring network traffic, the HCA platform 102 may intercept, copy, read, and/or otherwise access packets in the network traffic in order to identify a list of domain names corresponding to HTML webpages, or HTML webpage domain names, included in the network traffic. In some instances, based on identifying a list of HTML webpage domain names included in the network traffic, the HCA platform 102 may compare the list of HTML webpage domain names included in the network traffic to the watchlist of potentially malicious domain names. In these examples, based on identifying at least one HTML webpage domain name included in the network traffic that matches a domain name on the watchlist of potentially malicious domain names, the HCA platform 102 may identify the HTML webpage corresponding to the at least one HTML webpage domain name as a potentially malicious HTML webpage. Accordingly, the HCA platform 102 may receive a request to perform HCA on the potentially malicious HTML webpage. For example, the HCA platform 102 may receive the request via an electronic request generated automatically by the HCA platform 102 itself, based on instructions stored in memory (e.g., memory 112, and/or external memory) to cause performance of HCA on potentially malicious HTML webpages detected in network traffic, and/or by other methods).

Additionally or alternatively, in some examples, in receiving the request to perform HCA on a potentially malicious HTML webpage, the HCA platform 102 may receive a set of threat information that includes a plurality of threat records (e.g., a CTI feed, such as a CTI feed maintained and/or created by CTIP 104A and including CTI threat information on potentially malicious HTML webpages, and/or other sets of threat information). The HCA platform 102 may receive the set of threat information from a cybersecurity service and/or application, such as CSaaS 104, CTIP 104A, and/or other cybersecurity services and/or applications (e.g., in the same manner the HCA platform 102 received the watchlist described above, and/or by other methods). Each threat record in the set of threat information may include a domain name corresponding to a tracked HTML webpage (e.g., an HTML webpage identified as potentially malicious by a cyberanalyst employed by the provider of CSaaS 104, by a CTIP 104A, and/or by other individuals, devices, or entities). Each threat record may further include a confidence score associated with the respective domain name. The respective confidence scores may indicate a likelihood/probability that the respective tracked HTML webpage corresponds to a malicious HTML webpage. For example, the respective confidence scores may indicate a likelihood/probability that the tracked HTML webpage is malicious, based on its similarity to known malicious HTML webpages. Each confidence score may be a numerical value (e.g., an integer value, a percentage, a decimal value, and/or other numerical values) and/or an alphanumeric value (e.g., “A”, “B”, and/or other alphanumeric values).

In these examples, the HCA platform 102 may additionally receive an identification of an HTML webpage and/or a request to determine whether HCA should be performed on the HTML webpage. Based on receiving the identification of the HTML webpage and/or the request to determine whether HCA should be performed on the HTML webpage, the HCA platform 102 may compare the domain name of the HTML webpage to the set of threat information, to determine whether or not the domain name of the HTML webpage is included in the set of threat information. In some examples, based on determining that the domain name of the HTML webpage is included in the set of threat information, the HCA platform 102 may compare the confidence score associated with the domain name of the HTML webpage and included in the same threat record as the domain name of the HTML webpage to determine whether or not the confidence score satisfies a risk threshold value. The risk threshold value may be determined and/or otherwise supplied to the HCA platform 102 by a user (e.g., a cyberanalyst associated with CSaaS 104) and/or by a CTI feed (e.g., a CTI feed supplied by CTIP 104A). In some instances, based on determining that the confidence score of the HTML webpage satisfies the risk threshold value, the HCA platform 102 may determine that HCA platform 102 should be performed on the HTML webpage. Based on the determination that the risk threshold value is satisfied, the HCA platform 102 may identify the HTML webpage as a potentially malicious HTML webpage and may, in response, retrieve the HTML webpage (e.g., by using a web browser's HTTP client, by querying a database of preloaded webpages, and/or by other methods) and perform HCA on the HTML webpage (e.g., as described below at steps 520-560).

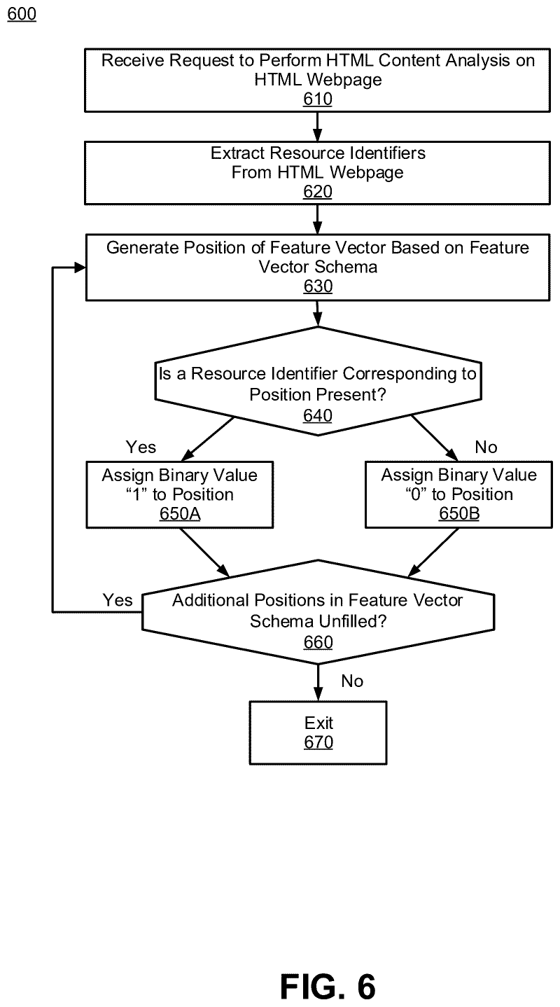

At step 520, a feature vector (e.g., a BAR) for the HTML webpage, corresponding to the request received at step 510, may be generated. For example, a BAR similar to legitimate webpage BAR 800, malicious webpage BAR 801, additional parameters BAR 802, parked/wildcard domain webpage BAR 803 and/or other BARs may be generated (e.g., as described above with respect to FIG. 8). The HCA platform 102 may generate the BAR for the HTML webpage using the BAR schema previously generated by the HCA platform 102 (e.g., as described above with respect to FIGS. 3 and 4). In generating the BAR for the HTML webpage, the HCA platform 102 may process the HTML webpage using the BAR schema. For example, the HCA platform 102 may process a potentially malicious HTML webpage by extracting the resource identifiers corresponding to each asset referenced in the potentially malicious HTML webpage. In some instances, the HCA platform 102 may generate an unfilled BAR for the potentially malicious HTML webpage based on the BAR schema, where each position in the unfilled BAR corresponds to a position mapped to a particular resource identifier by the BAR schema (e.g., as described above with respect to FIGS. 3 and 4). The HCA platform 102 may determine, for each position in the unfilled BAR, whether the potentially malicious HTML webpage includes a resource identifier corresponding to the resource identifier mapped to each respective position by the BAR schema. For example, the HCA platform 102 may, for each position in the unfilled BAR, parse, mine, analyze, and/or otherwise evaluate the set of resource identifiers extracted from the potentially malicious HTML webpage and identify whether the resource identifier mapped to the respective position is included in the set of resource identifiers extracted from the potentially malicious HTML webpage. For each position in the unfilled BAR, the HCA platform 102 may assign a binary value “1” to indicate that the resource identifier mapped to the position by the BAR schema is present in the set of resource identifiers extracted from the potentially malicious HTML webpage or a binary value “0” to indicate that the resource identifier mapped to the position by the BAR schema is not present in the set of resource identifiers extracted from the potentially malicious HTML webpage. An example method for processing potentially malicious HTML webpages and generating BARs using the steps described above is illustrated by FIG. 6, described in further detail below.

FIG. 6 shows an example method of generating a feature vector, such as a binary asset representation, for an HTML webpage to perform HCA in accordance with one or more example arrangements. Referring to FIG. 6, a feature vector generation method 600 may begin at step 610, when a request to perform HCA on an HTML webpage (e.g., a potentially malicious HTML webpage, and/or a potentially parked/wildcard domain webpage) is received. For example, an HCA platform 102 may receive the request from one or more sources, as described above at step 510 of FIG. 5. Based on receiving the request, the HCA platform 102 may generate the BAR for the HTML webpage using the BAR schema and as described below at steps 620-670. Although FIG. 6 is described herein as generating a BAR for a potentially malicious HTML webpage, it should be understood that this is merely an example of a feature vector generated by feature vector generation method 600 and that other feature vectors may be generated and that BARs for other types of HTML webpages, for example, parked/wildcard domain HTML webpages, may be generated without departing from the scope of this disclosure.

At step 620, the HCA platform 102 may extract the resource identifiers corresponding to each asset referenced in an HTML webpage, such as the example potentially malicious HTML webpage described herein. For example, HCA platform 102 may read, mine, and/or otherwise parse the HTML code included in the potentially malicious HTML webpage and extract each resource identifier included in the HTML code (e.g., by creating a copy (e.g., in a file, and/or by other means) of each resource identifier, by calling an application program interface (API) to extract each resource identifier, and/or by other methods of extracting resource identifiers). In some examples, the HCA platform 102 may retrieve the HTML code via a link (e.g., a URL link to a website corresponding to a domain name and hosted by a web server connected to a network) and/or other reference to the potentially malicious HTML webpage. For instance, HCA platform 102 may, based on a link and/or other reference to the potentially malicious HTML webpage, use web scraping to extract the underlying HTML code of the potentially malicious HTML webpage and may replicate the code in internal memory (e.g., memory 112, and/or other memory) of the HCA platform 102. Similar to Step 310 and Step 410 above, a retrieved HTML webpage may include URL links that further redirect a browser to other (child) HTML webpages that may be recursively retrieved. Recursive retrieval may continue until a preconfigured trigger for ending recursive retrieval is satisfied. For example, recursive retrieval may continue until a (configurable) recursion depth limit is reached. Additionally or alternatively, recursive retrieval may continue until a loop is encountered where a child HTML webpage redirects to one or more parent HTML webpages. Accordingly, HCA platform 102 may extract the resource identifiers from the replicated HTML code without ever executing HTML (e.g., without causing the potentially malicious HTML webpage to be displayed on a web browser or otherwise rendered by a web browser).

After extracting all the resource identifiers corresponding to each asset referenced in the potentially malicious HTML webpage, the HCA platform 102 may generate the BAR for the potentially malicious HTML webpage. In some instances, the HCA platform 102 may generate the BAR for the potentially malicious HTML webpage using a looped sequence of steps to generate each position in the BAR and assign a binary value to each respective position in the BAR. For example, the HCA platform 102 may generate the BAR using the looped sequence of steps described below with respect to steps 630-660.

At step 630, the HCA platform 102 may generate a position of the BAR based on the BAR schema. For example, the HCA platform 102 may generate an unfilled position (e.g., a blank, null character, placeholder binary value, and/or other unfilled position) in the string of binary values that cumulatively form the BAR. The unfilled position may be mapped to a particular resource identifier based on the mapping of the BAR schema. For example, a BAR schema (which may, e.g., have been generated as described above at steps 320 and 410-470, with respect to FIGS. 3 and 4) may have mapped a particular position in a BAR to a particular resource identifier (e.g., “unknown.com” and/or other resource identifiers). Accordingly, the HCA platform 102 may generate a position of the BAR for the potentially malicious HTML webpage as an unfilled position mapped to the same particular resource identifier (e.g., “unknown.com” and/or other resource identifiers). In some cases, the HTML webpage being analyzed may reference assets that are not known to the BAR schema. For example, the HTML webpage being analyzed (e.g., as requested in step 510) may reference assets that were not included in the training set used to generate the schema as described at steps 410-470. Accordingly, there may not be resource identifiers and associated BAR schema positions corresponding to the (unknown) referenced assets. When the unknown assets correspond to HTML webpages, then HCA techniques as described herein may be applied to these (unknown) HTML webpages (e.g., in an additional and/or separate iteration of the steps described herein with respect to FIGS. 3-7). In these examples, the results of applying HCA to the unknown HTML webpages (e.g., the risk indicators for an (unknown) HTML webpage, generated as described at step 530), may be cached (e.g., in memory 112 of the HCA platform 102, and/or other memory). Subsequently, when the results (e.g., the risk indicator) of the original HTML webpage being analyzed is being computed as described in step 530 below, the cached HCA results of the unknown assets may be factored into the computation of the risk indicator for the original HTML webpage being analyzed.

At step 640, the HCA platform 102 may identify whether the potentially malicious HTML webpage includes the resource identifier mapped to the unfilled position. For example, the HCA platform 102 may parse, read, mine, analyze, and/or otherwise evaluate a list of the resource identifiers extracted from the potentially malicious HTML webpage (e.g., as described above at step 620) to identify whether the list includes the resource identifier mapped to the unfilled position. For instances, in some examples, the resource identifier mapped to the unfilled position may be “unknown.com.” In these examples, the HCA platform 102 may parse, read, mine, analyze, and/or otherwise evaluate the list of resource identifiers extracted from the potentially malicious HTML webpage to identify whether “unknown.com” is included in the list. Based on identifying that the resource identifier mapped to the unfilled position is included in the potentially malicious HTML webpage, the HCA platform 102 may proceed to step 650A and assign a binary value of “1” to the unfilled position, thus filling the unfilled position. Based on identifying that the resource identifier mapped to the unfilled position is not included in the potentially malicious HTML webpage, the HCA platform 102 may proceed to step 650B and assign a binary value of “0” to the unfilled position, thus filling the unfilled position.

Additionally or alternatively, in some instances, the HCA platform 102 may identify whether an additional parameter mapped to the unfilled position is satisfied. For example, the HCA platform 102 may determine one or more of: whether a threshold number of redirects associated with a request to access the potentially malicious HTML webpage is satisfied, whether a threshold percentage of CPU usage is satisfied, whether a threshold number of return functions is satisfied, whether a threshold number of variant webpages associated with the potentially malicious HTML webpage is satisfied, and/or whether other additional parameters are satisfied (e.g., as described above at step 450 of FIG. 4). In identifying whether an additional parameter mapped to the unfilled position is satisfied, the HCA platform 102 may use webscraping and/or other methods of parsing/mining/evaluating the HTML source code of the potentially malicious HTML webpage. Accordingly, the HCA platform 102 may identify whether an additional parameter mapped to the unfilled position is satisfied without causing execution of HTML and/or causing the potentially malicious HTML webpage to be displayed on a web browser. Based on identifying that the additional parameter mapped to the unfilled position is satisfied, the HCA platform 102 may proceed to step 650A and assign a binary value of “1” to the unfilled position, thus filling the unfilled position. Based on identifying that the additional parameter mapped to the unfilled position is satisfied, the HCA platform 102 may proceed to step 650B and assign a binary value of “0” to the unfilled position, thus filling the unfilled position.

It should be understood that the description of assigning values to the unfilled positions at steps 650A and 650B is merely an example and that in one or more instances the binary values assigned to an unfilled position may be switched based on one or more factors (e.g., user preferences, rules set by CSaaS 104, and/or other factors). For example, a binary value of “0” may be assigned to indicate that a resource identifier is present in the potentially malicious HTML webpage.

At step 660, the HCA platform 102 may determine whether any positions in the BAR schema remain unfilled and/or are not included in the BAR for the potentially malicious HTML webpage. For example, the HCA platform 102 may compare the BAR for the potentially malicious HTML webpage to the BAR schema to determine whether each mapped position of the BAR schema has a corresponding filled position in the BAR for the potentially malicious HTML webpage. For instance, consider an example where a BAR schema was generated by HCA platform 102 that maps five resource identifiers to positions in a BAR. In this example, the HCA platform 102 may determine whether five positions, each mapped to a respective one of the five resource identifiers, have been generated and assigned values (e.g., as described above with respect to steps 630-650A or 650B). Accordingly, in this example, the HCA platform 102 may determine that each position in the BAR schema is filled only if the BAR for the potentially malicious HTML webpage is a binary string of five binary values, where each value indicates the presence or absence of a respective resource identifier of the five resource identifiers. Based on determining that at least one position in the BAR schema is unfilled and/or is not included in the BAR for the potentially malicious HTML webpage, the HCA platform 102 may proceed to generate the next position in the BAR for the potentially malicious HTML webpage and assign a binary value to it (e.g., by repeating the functions described above at steps 630-660). Based on determining that no position in the BAR schema remain unfilled and/or are not included in the BAR for the potentially malicious HTML webpage, the HCA platform 102 may determine that the process of generating the BAR for the potentially malicious HTML webpage has been completed and accordingly the method may exit/end (670).

Referring again to FIG. 5, at step 530, a risk indicator may be generated based on the BAR for the potentially malicious HTML webpage. For example, the HCA platform 102 may generate the risk indicator by inputting the BAR for the potentially malicious HTML webpage into the content analysis model and/or inputting any cached results of applying HCA to unknown assets (e.g., as described in step 630 above). A risk indicator may indicate a likelihood that the potentially malicious HTML webpage corresponds to a malicious HTML webpage. For example, the risk indicator may be a binary value (e.g., a “1” indicating a 100% likelihood that the potentially malicious HTML webpage corresponds to a malicious HTML webpage, a “0” indicating a 0% likelihood that the potentially malicious HTML webpage corresponds to a malicious HTML webpage, and/or other values indicating other percentages). Additionally or alternatively, in some instances, the risk indicator may estimate a confidence score referencing a likelihood/probability (e.g., an integer value, a decimal value (e.g., between 0 and 1, and/or other values), a percentage value (e.g., between 0% and 100%), and/or other values) that a given potentially malicious HTML webpage corresponds to a malicious HTML webpage.

In generating the risk indicator by inputting the BAR or the BAR and the cached results for the potentially malicious HTML webpage into the content analysis model, the HCA platform 102 may cause the content analysis model to use some or all of stored correlations used to train the content analysis model (e.g., as described above at step 340). For example, the HCA platform 102 may cause the content analysis model to compare the BAR for the potentially malicious HTML webpage to one or more stored correlations. The content analysis model may compare the BAR to stored correlations between known assets and known malicious HTML webpages. In comparing the BAR to stored correlations of known assets and known malicious HTML webpages, the content analysis model may generate the risk indicator based on/based in part on a number of malicious resources included in the potentially malicious HTML webpage.

Consider an example where the BAR for the HTML webpage (e.g., the potentially malicious HTML webpage) is, or is similar to, malicious webpage BAR 801 (as depicted in FIG. 8). The content analysis model may compare malicious webpage BAR 801 to one or more stored correlations indicating that “g0ggle[.]com” and “unknown[.]com” are resource identifiers corresponding to assets included in known malicious HTML webpages. Based on comparing malicious webpage BAR 801 the one or more stored correlations, the content analysis model may identify that malicious webpage BAR 801 includes a binary value of “1” at the position corresponding to “g0ggle[.]com,” indicating that the asset is included in the potentially malicious HTML webpage. The content analysis model may further identify that malicious webpage BAR 801 includes a binary value of “0” at the position corresponding to “unknown[.]com,” indicating that the asset is not included in the potentially malicious HTML webpage. Based on these comparisons, the content analysis model may generate the risk indicator as a confidence score of 50%, because the BAR (malicious webpage BAR 801, in this example) for the potentially malicious HTML webpage included one of two known assets included in known malicious HTML webpages. It should be understood that this is merely an example and confidence scores of different values may be generated based on different comparisons, different stored correlations, different known assets, and/or other factors described herein for determining a likelihood that a potentially malicious HTML webpage corresponds to a malicious HTML webpage.

Consider an alternative example for determining whether an HTML webpage is a parked/wildcard domain HTML webpage, where the BAR for the HTML webpage is, or is similar to, parked/wildcard domain webpage BAR 803 (as depicted in FIG. 8). The content analysis model may compare parked/wildcard domain webpage BAR 803 to one or more stored correlations indicating that “fct[.]co”, “schema[.]org”, and “w3[.]org” are resource identifiers corresponding to assets included in known parked/wildcard domain HTML webpages. Based on comparing parked/wildcard domain webpage BAR 803 to the one or more stored correlations, the content analysis model may identify that parked/wildcard domain webpage BAR 803 includes a binary value of “1” at the positions respectively corresponding to “w3[.]org”, “fct[.]co”, “blogger[.]com”, and “schema[.]org” indicating that the assets are included in the HTML webpage. The content analysis model may further identify that parked/wildcard domain webpage BAR 803 includes a binary value of “0” at the respective positions corresponding to “google[.]com” and “facebook[.]com” indicating that the assets are not included in the HTML webpage. Based on these comparisons, the content analysis model may generate the risk indicator as a confidence score of 75%, because the BAR (parked/wildcard domain webpage BAR 803, in this example) for the HTML webpage included four total assets, three of which are known parked/wildcard domain assets. It should be understood that this is merely an example and confidence scores of different values may be generated based on different comparisons, different stored correlations, different known assets, and/or other factors described herein for determining a likelihood that an HTML webpage corresponds to and/or is a known parked/wildcard domain HTML webpage.

Additionally or alternatively, in some examples, the content analysis model may generate the risk indicator based on a determination that a number of assets, included in the potentially malicious HTML webpage and corresponding to known malicious HTML webpages, satisfies a threshold value (e.g., by comparing some or all of the stored correlations to the BAR for the potentially malicious HTML webpage). For example, based on comparing some or all of the stored correlations to the BAR for the potentially malicious HTML webpage, the content analysis model may identify a number and/or percentage of assets included in the potentially malicious HTML webpage that are also included in one or more known malicious HTML webpages. In some examples, the content analysis model may have been configured to detect/identify any number of assets (e.g., based on the training received from HCA platform 102, as described above at step 340). In these examples, the content analysis model may compare the number and/or percentage of assets included in the potentially malicious HTML webpage that are also included in one or more known malicious HTML webpage to a threshold value.

For instance, consider again the example where the BAR for the potentially malicious HTML webpage is, or is similar to, malicious webpage BAR 801 (as depicted in FIG. 8). The content analysis model may compare malicious webpage BAR 801 to one or more stored correlations indicating that “g0ggle[.]com” and “unknown[.]com” are resource identifiers corresponding to known assets that are included in and/or associated with known malicious HTML webpages, as described above. In one or more examples, the content analysis model may determine, based on the comparison, that the BAR for the potentially malicious HTML webpage (malicious webpage BAR 801) includes one known asset (“g0ggle[.]com”) that is included in and/or associated with one or more known malicious HTML webpages. The content analysis model may compare the number of assets, included in and/or associated with one or more known malicious HTML webpages, identified by the BAR (one) to a threshold value that may, e.g., be satisfied if the number of such assets meets or exceeds two assets. Accordingly, in this example, the content analysis model may generate a risk indicator that indicates a low likelihood/percentage that the potentially malicious HTML webpage corresponds to a malicious HTML webpage (e.g., a binary value of “0”, a confidence score with a percentage below a predetermined percentage that indicates “low likelihood” (e.g., 50%, 10%, 5%, and/or other percentages), and/or other risk indicators) based on determining that the number of known assets, included in and/or associated with one or more known malicious HTML webpages, identified by the BAR (one) does not satisfy the threshold value (two). It should be understood that the content analysis model could perform the functions described above on any scale. For example, the BAR for the potentially malicious HTML webpage may include hundreds, thousands, tens of thousands, or any other number of positions mapped to resource identifiers included in the potentially malicious HTML webpage. Similarly, the threshold value may be any value and may, in some instances, be determined and/or otherwise supplied to the HCA platform 102 by a user (e.g., a cyberanalyst associated with CSaaS 104) and/or by a CTI feed (e.g., a CTI feed supplied by CTIP 104A).

Additionally or alternatively, in some instances, the content analysis model may generate the risk indicator based on a determination that a similarity score indicating a correlation between the BAR for the potentially malicious HTML webpage and one or more BARs for one or more HTML webpages corresponding to domain names of the training set exceeds a threshold value. For example, the content analysis model may compare the BAR for the potentially malicious HTML webpage to BARs for each respective HTML webpage corresponding to domain names of the training set. For each comparison, the content analysis model may generate a similarity score indicating a number and/or percentage of assets shared, based on the BARs, between the potentially malicious HTML webpage and each respective HTML webpage corresponding to domain names of the training set. The content analysis model may compare similarity scores to a threshold value. the threshold value may be any value and may, in some instances, be determined and/or otherwise supplied to the HCA platform 102 by a user (e.g., a cyberanalyst associated with CSaaS 104) and/or by a CTI feed (e.g., a CTI feed supplied by CTIP 104A). Based on a determination that a similarity score exceeds the threshold value, the content analysis model may generate a risk indicator that matches a risk indicator associated with the respective HTML webpage corresponding to domain names of the training set. For example, based on a determination that a similarity score for a known malicious HTML webpage corresponding to domain names of the training set exceeds the threshold value, the content analysis model may generate a risk indicator of 100%, indicating, based on its similarity to a known malicious HTML webpage exceeding a threshold value, the potentially malicious HTML webpage corresponds to a malicious HTML webpage.

Additionally or alternatively, in some instances, the HCA platform 102 may have previously trained the content analysis model (e.g., as described above at step 340) to employ one or more algorithms to generate risk indicators. The algorithms may be configured to perform the functions described above to generate risk indicators, and/or may be other algorithms configured to perform different functions. For example, the HCA platform 102 may have previously trained the content analysis model to employ a content analysis algorithm to determine whether a percentage of known assets, included in and/or associated with known malicious HTML webpages, that are also included in the BAR for the potentially malicious HTML webpage satisfies a threshold percentage.

In an example of the content analysis model employing a content analysis algorithm as described above, suppose again that the BAR for the potentially malicious HTML webpage is/is similar to malicious webpage BAR 801 (as depicted in FIG. 8). The content analysis model may compare malicious webpage BAR 801 to one or more stored correlations indicating that “g0ggle[.]com” and “unknown[.]com” are resource identifiers corresponding to known assets included in and/or associated with known malicious HTML webpages as described above. In one or more examples, the content analysis model may determine, based on the comparison, that the BAR for the potentially malicious HTML webpage (malicious webpage BAR 801) includes one known asset included in and/or associated with known malicious HTML webpages, three known legitimate assets (“w3[.]org”, “twitter[.]com”, “youtube[.]com”), and four total assets. The content analysis model may also include a threshold percentage satisfied by a percentage of known assets, included in and/or associated with known malicious HTML webpages and included in a potentially malicious HTML webpage, that meets or exceeds 25%. In generating the risk indicator, the content analysis model may execute a content analysis algorithm using the following constraints/parameters:

Parameter 1: If the percentage value of the number of known assets, included in and/or associated with one or more known HTML webpages and included in the potentially malicious HTML webpage, divided by the total number of assets present in the potentially malicious HTML webpage meets or exceeds 25%, then the risk indicator represents a high likelihood that the potentially malicious HTML webpage corresponds to a malicious HTML webpage. Parameter 2: Else, the risk indicator represents a low likelihood that the potentially malicious HTML webpage corresponds to a malicious HTML webpage.

In this example, if the percentage value of (the known assets (included in and/or associated with one or more known malicious HTML webpages) present in the potentially malicious HTML webpage divided by the total number of assets present in the HTML webpage) is greater than or equal to 25%, indicating that the threshold percentage is satisfied, the content analysis model generates a risk indicator that indicates a high likelihood the potentially malicious HTML webpage corresponds to a malicious HTML webpage. Else, the content analysis model generates a risk indicator that indicates a low likelihood the potentially malicious HTML webpage corresponds to a malicious HTML webpage. Accordingly, based on the example algorithm above, the content analysis model may generate a risk indicator that indicates a high likelihood the potentially malicious HTML webpage corresponds to a malicious HTML webpage, because one out of four of the assets identified by malicious webpage BAR 801 as being included in the potentially malicious HTML webpage are known assets that are included in and/or associated with one or more known malicious HTML webpages.

In another example of the content analysis model employing a content analysis algorithm as described above (e.g., to determine a likelihood that an HTML webpage is a parked/wildcard domain HTML webpage), suppose that the BAR for the HTML webpage is/is similar to parked/wildcard domain webpage BAR 803 (as depicted in FIG. 8). The content analysis model may compare parked/wildcard domain webpage BAR 803 to one or more stored correlations indicating that “w3[.]org”, “fct[.]co”, and “blogger[.]com”, are resource identifiers corresponding to known assets included in and/or associated with known parked/wildcard domain HTML webpages as described above. Based on comparing parked/wildcard domain webpage BAR 803 to the one or more stored correlations, the content analysis model may identify that parked/wildcard domain webpage BAR 803 includes a binary value of “1” at the positions respectively corresponding to “w3[.]org”, “fct[.]co”, “blogger[.]com”, and “schema[.]org” indicating that the assets are included in the HTML webpage. The content analysis model may further identify that parked/wildcard domain webpage BAR 803 includes a binary value of “0” at the respective positions corresponding to “google[.]com” and “facebook[.]com” indicating that the assets are not included in the HTML webpage. In one or more examples, the content analysis model may determine, based on the comparison, that the BAR for the potentially parked/wildcard domain HTML webpage (parked/wildcard domain webpage BAR 803) includes three known assets included in and/or associated with known parked/wildcard domain HTML webpages, one known legitimate asset (“schema[.]org”) that is not associated with known parked/wildcard domain HTML webpages, and four total assets. The content analysis model may also include a threshold percentage satisfied by a percentage of known assets, included in and/or associated with known parked/wildcard domain HTML webpages and included in a potentially parked/wildcard domain HTML webpage, that meets or exceeds 75%. In generating the risk indicator, the content analysis model may execute a content analysis algorithm using the following constraints/parameters:

Parameter 1: If the percentage value of the number of known assets, included in and/or associated with one or more known parked/wildcard domain HTML webpages and included in the potentially parked/wildcard domain HTML webpage, divided by the total number of assets present in the potentially parked/wildcard domain HTML webpage meets or exceeds 75%, then the risk indicator represents a high likelihood that the potentially parked/wildcard domain HTML webpage corresponds to a parked/wildcard domain HTML webpage. Parameter 2: Else, the risk indicator represents a low likelihood that the potentially parked/wildcard domain HTML webpage corresponds to a parked/wildcard domain HTML webpage.

Additionally or alternatively, an algorithm as described herein may include a threshold satisfied by a maximum number of assets included in a potentially parked/wildcard domain HTML webpage. For example, the content analysis model may employ an algorithm that generates a risk indicator indicating a high likelihood that the potentially parked/wildcard domain HTML webpage corresponds to a parked/wildcard domain HTML webpage based on determining that a potentially parked/wildcard domain HTML webpage includes at least one known parked/wildcard domain asset and does not have a number of assets exceeding the maximum number of assets. For instance, referring to parked/wildcard domain webpage BAR 803 as described above, if the threshold is four total assets, the content analysis model may generate a risk indicator indicating a high likelihood that the potentially parked/wildcard domain HTML webpage corresponds to a parked/wildcard domain HTML webpage because the parked/wildcard domain webpage BAR 803 indicates the potentially parked/wildcard domain HTML webpage includes four total assets (e.g., the maximum number of assets is not exceeded) and at least one known parked/wildcard domain asset (e.g., “fct[.]co”). Whether a risk indicator is “high likelihood” may be based on parameters supplied to the HCA platform 102 by a user (e.g., a cyberanalyst associated with CSaaS 104) and/or by a CTI feed (e.g., a CTI feed supplied by CTIP 104A). For example, a “high likelihood” risk indicator may be and/or include a binary value of “1”, a confidence score with a percentage above a predetermined percentage that indicates “high likelihood” (e.g., 51%, 80%, 100%, and/or other percentages), and/or other risk indicators. Similarly, whether a risk indicator is “low likelihood” may be based on parameters supplied to the HCA platform 102 by a user (e.g., a cyberanalyst associated with CSaaS 104) and/or by a CTI feed (e.g., a CTI feed supplied by CTIP 104A). For example, a “low likelihood” risk indicator may be and/or include a binary value of “0”, a confidence score with a percentage below a predetermined percentage that indicates “high likelihood” (e.g., 50%, 10%, 5%, and/or other percentages), and/or other risk indicators.

It should be understood that the above examples are not limiting in scope/scale and that the content analysis model may use any amount of stored correlations, various different BARs for additional HTML webpages, various different threshold values/percentages, additional algorithms, and/or any other factors described herein, in order to generate the risk indicator for the HTML webpage.

In some instances, after generating the risk indicator for the HTML webpage (e.g., before outputting the risk indicator as described below at step 540, and/or at other times), the HCA platform 102 may modify the risk indicator based on additional inputs (e.g., risk indicator modifiers received from a database of known assets 104C or CTIP 104A, as described above at block 202 with respect to FIG. 2). FIG. 7 shows an example method of modifying a risk indicator (e.g., a risk indicator generated during HCA) based on undetected assets in accordance with one or more example arrangements.

Referring to FIG. 7, an example risk indicator modification method 700 may modify a risk indicator based on undetected assets (e.g., assets for which the BAR for a potentially malicious HTML webpage indicates no resource modifier corresponding to the undetected asset was extracted from the potentially malicious HTML webpage). At step 710, an asset absent from an HTML webpage, such as a potentially malicious HTML webpage as described herein, may be determined. For example, HCA platform 102 may determine an asset absent from the potentially malicious HTML webpage by parsing, analyzing, and/or otherwise searching the BAR for the potentially malicious HTML webpage to identify whether a resource indicator corresponding to a particular asset was extracted from the potentially malicious HTML webpage. In searching the BAR for the potentially malicious HTML webpage, the HCA platform 102 may search for a resource identifier corresponding to a particular asset based on input from a CTI feed (e.g., a CTI feed received from CTIP 104A as a risk indicator modifier). For example, as described above at block 202, in some instances the HCA platform 102 may receive a CTI feed from CTIP 104A as additional input to an HCA process. The CTI feed may include one or more CTI reports that include threat information identifying known assets that are included in and/or associated with one or more known malicious HTML webpages. In some instances, the threat information may identify one or more known assets, that are included in and/or associated with one or more known malicious HTML webpages, that correspond to a confidence level (e.g., an integer value, a decimal value (e.g., between 0 and 1, and/or other values), a percentage value (e.g., between 0% and 100%), and/or other values) that an HTML webpage including the one or more known assets corresponds to a malicious HTML webpage. In some examples, the confidence level may be included in the CTI feed and/or may be separately received by the HCA platform 102 from a database of known assets 104C maintained as part of CSaaS 104. Thus, in some examples, the HCA platform 102 may search for a resource identifier corresponding to a known asset of the one or more known assets included in and/or associated with one or more known malicious HTML webpages described above. Based on determining that the resource identifier corresponding to such an asset is not included in the BAR for the potentially malicious HTML webpage, the HCA platform 102 may determine that the known asset included in and/or associated with one or more known malicious HTML webpages is an asset absent from the potentially malicious HTML webpage.

At step 720, based on determining the asset absent from the potentially malicious HTML webpage, a weight of the asset absent from the potentially malicious HTML webpage may be determined. For example, the HCA platform 102 may determine the weight for the asset absent from the potentially malicious HTML webpage based on one or more risk indicator modifiers that may, e.g., be included in the CTI feed and/or the database of known assets 104C (e.g., as described above at step 710). Consider an example where the asset absent from the potentially malicious HTML webpage is an asset, included in and/or associated with a known malicious HTML webpage, and/or identified in a threat record of a CTI feed. The HCA platform 102 may identify a weight (e.g., a multiplier, such as an integer, decimal value, or percentage, an increment/decrement amount, such as an integer, decimal, or percentage, and/or other weights) corresponding to the asset based on, e.g., a stored correlation, indicator, and/or other record of the confidence level. The record of the confidence level may be included in the CTI feed and/or the database of known assets 104C. For example, in identifying the weight the HCA platform 102 may, in some instances, identify a multiplier and/or an increment/decrement amount to apply to a risk indicator for the potentially malicious HTML webpage.

In some instances, the weight may correspond to a likelihood that the asset absent from the potentially malicious HTML webpage indicates that an HTML webpage corresponds to a malicious HTML webpage. For instance, a human cyberanalyst and/or a cybersecurity program may (e.g., as part of a CSaaS 104) determine that the known asset, included in and/or associated with one or more known malicious HTML webpages and described above, corresponds to a 5% likelihood that an HTML webpage that includes the same asset is a malicious HTML webpage. In this instance, the HCA platform 102 may accordingly determine the weight for the known asset (and thus, the weight for the asset absent from the potentially malicious HTML webpage) is a decrement value of 5%.

At step 730, based on determining the weight of the asset absent from the potentially malicious HTML webpage, a risk indicator corresponding to the potentially malicious HTML webpage may be adjusted. For example, the HCA platform 102 may adjust the risk indicator based on the weight. In some examples, as described above, the weight may be a multiplier. In these examples, the HCA platform 102 may modify the risk indicator for the potentially malicious HTML webpage by multiplying the risk indicator by the multiplier. For instance, the weight may be a multiplier of 0.5 which may, e.g., indicate that the risk indicator of a potentially malicious HTML webpage that does not include the asset absent from the potentially malicious HTML webpage (e.g., as determined above at step 710) should be reduced by a factor of one-half. Accordingly, the risk indicator for the potentially malicious HTML webpage (e.g., 1.0) may be multiplied by the multiplier (0.5) to produce a modified risk indicator (e.g., 0.5, one-half of 1.0).

Additionally or alternatively, in some instances the weight may be an increment/decrement value. In these instances, the HCA platform 102 may modify the risk indicator by the increment/decrement value. For instance, as described above at step 720, the weight may be a decrement value of 5%, which may indicate that potentially malicious HTML webpages that do not include the asset absent from the potentially malicious HTML webpage (e.g., as determined above at step 710) should be reduced by 5% because, e.g., they are 5% less likely to be malicious. Accordingly, the risk indicator for the potentially malicious HTML webpage (e.g., 50%) may be decremented by the weight (e.g., 5%) to produce a modified risk indicator (e.g., 45%).

It should be understood that any and/or all of the functions described above at steps 710-730 may be performed by and/or using the content analysis model. For example, the content analysis model may have previously been trained to include one or more stored correlations between particular assets and the weights to apply to risk indicators for potentially malicious HTML webpages that do not include the particular assets. Accordingly, the content analysis model may perform the functions described above at steps 710-730 using the stored correlations.

At step 740, based on modifying the risk indicator for the potentially malicious HTML webpage, the modified risk indicator may be outputted. For example, the HCA platform 102 may output the modified risk indicator using the same functions (and causing similar effects) as described below at step 540. At step 750, a computing device performing HCA (e.g., HCA platform 102) may determine whether a new determination of maliciousness for the potentially malicious HTML webpage (e.g., a determination from a human cyberanalyst and/or from a security program included in CSaaS 104) has been received. Based on determining that a new determination of maliciousness has been received, at step 760A, the content analysis model may be retrained and/or otherwise updated. For example, the HCA platform 102 may retrain and/or otherwise update the content analysis model using the functions and methods described below at step 560. Based on determining that a new determination of malicious has not been received (e.g., after waiting a predetermined period of time and/or receiving an indication confirming the risk indication as accurate), the method may exit/end (760B).

It should be understood that the functions described above at steps 710-760 may be repeated for any number of additional unidentified assets without departing from the scope of this disclosure.

Referring again to FIG. 5, at step 540, a risk indicator may be output. For example, HCA platform 102 may cause output of a risk indicator (e.g., the risk indicator generated above at step 530 and/or the modified risk indicator described by steps 710-730). The HCA platform 102 may cause the risk indicator to be outputted via the communication interface 113 and while a data connection is established.

In some instances, the risk indicator may be outputted to one or more cyber defense systems, services, and/or devices. For example, a cyber defense system and/or service may be operated by a CSaaS provider (e.g., CSaaS 104) that may use cyber threat intelligence (CTI) to detect cyber threats in network traffic and/or take appropriate defensive/protective actions (e.g., cybersecurity actions) based on such threats. As described herein, a CTI provider CTIP 104A may supply CTI to the CSaaS 104 in the form of network addresses, such as IP addresses, 5-tuple information, domain names, URLs, and/or any other form, that may be associated with cyber threats and/or attacks. Such cyber threats and/or attacks may be associated with, for example, malware servers, phishing emails, ransomware, and any other type and/or source of cyber threat and/or attack. Additionally or alternatively, in some instances, the CTIP 104A may supply CTI that includes information relating to HCA. For example, the CTIP 104A may supply CTI that includes network addresses corresponding to potentially malicious HTML webpages and/or the potentially malicious HTML webpages' respective risk indicators (e.g., risk indicators generated using the HCA techniques described herein).

Accordingly, in some instances, based on causing output of the risk indicator the HCA platform 102 may further cause additions and/or updates to CTI supplied by CTIP 104A. For example, based on outputting a risk indicator, for a potentially malicious HTML webpage, that satisfies a threshold risk value (which may, e.g., be determined by an employee of CSaaS 104 and/or other individuals), the HCA platform 102 may cause a new threat intelligence record to be generated. The new threat intelligence record may be and/or include the domain name of the potentially malicious HTML webpage corresponding to the risk indicator (e.g., by including the network address of the potentially malicious HTML webpage, by listing the domain name of the potentially malicious HTML webpage in a digital file, by including other metadata corresponding to the potentially malicious HTML webpage, and/or by other means). In some instances, the new threat intelligence record may additionally include domain names corresponding to one or more additional potentially malicious HTML webpages that HCA platform 102 also performed HCA techniques described herein on (e.g., via additional iterations of the methods described herein). Additionally or alternatively, in some instances, based on outputting a risk indicator that satisfies the threshold risk value the HCA platform 102 may cause an update to an existing threat intelligence record. For example, the HCA platform 102 may cause CTIP 104A to update an existing threat intelligence record to include the domain name of the potentially malicious HTML webpage corresponding to the risk indicator (e.g., by including the network address of the potentially malicious HTML webpage, by listing the domain name of the potentially malicious HTML webpage in a digital file, by including other metadata corresponding to the potentially malicious HTML webpage, and/or by other means).

In some instances, the new threat intelligence record and/or the updated threat intelligence record may be added to a CTI feed. For example, in addition to being a provider of a CSaaS service for network protection, CSaaS 104 also may be (and/or be associated with) a CTI provider CTIP 104A that publishes feeds of CTI that it generates to subscribers. As new and/or updated threat intelligence records are generated, they may be added to a CTI feed for malicious HTML webpages and/or domain names corresponding to malicious HTML webpages, and/or published to subscribers (e.g., SPMSs 104B). In some examples, the new threat intelligence record and/or updated threat intelligence record may comprise domain names of potentially malicious HTML webpages that were previously included in a low-confidence CTI feed. In these examples, based on performing the HCA techniques described herein to generate the new and/or updated threat intelligence records, adding the new and/or updated threat intelligence records to the CTI feed may cause the CTI feed to be associated with a high confidence level of the HTML webpages corresponding to the domain names being malicious HTML webpages.

The output of HCA techniques described herein may be applied to multiple CTI feeds. For example, there may be a large ecosystem of CTI providers that supply CTI in the form of network threat indicators (e.g., IP addresses, domain names, URLs, and the like) associated with malicious activity on the Internet. CTIPs may deliver their CTI as lists, or (streaming) feeds, of indicators, where each feed may be characterized by indicator type (e.g., IP addresses, domain names, URLs, and/or any other indicator), associated threat type (e.g., phishing, command & control, scanning, and/or any other threat type), confidence level (e.g., low, medium, or high confidence), severity, and/or any other characteristic.

CTIPs 150 may publish lists, or feeds, of records of potentially malicious HTML webpages and/or parked/wildcard domain HTML webpages, and/or of domain names that correspond to malicious HTML webpages and/or parked/wildcard domain HTML webpages. Organizations such as CSaaS providers (e.g., CSaaS 104) may subscribe to these feeds and may, for example, use the information in a cyber defense system. In some examples (e.g., often), the CTIPs may not identify which potentially malicious HTML webpages corresponding to domain names in their feeds may be malicious HTML webpages, which may be because the CTIPs' human cyberanalysts need tools like the HCA solution disclosed herein, for example, in order to handle the volume of domain names corresponding to new potentially malicious HTML webpages that their automated CTI creation systems may be generating. As the CTI feeds are received, a subscriber such as CSaaS 104 may then apply its HCA solution logic to the potentially malicious HTML webpages corresponding to domain names included in the feeds. If the HCA solution produces a risk indicator for a potentially malicious HTML webpage, then the potentially malicious HTML webpage may be associated with the risk indicator as metadata. Such metadata may then be used to improve the effectiveness of the CSaaS service. A similar description applies for parked/wildcard domain HTML webpages.

Additionally or alternatively, in at least some examples, outputting the risk indicators generated during HCA may cause human analysis. Accordingly, in these examples, outputting the risk indicator may further cause human analysis to be performed on the risk indicator and the potentially malicious HTML webpage. For example, a final determination of whether or not a potentially malicious HTML webpage corresponds to a malicious HTML webpage, and thus a determination of false positives and/or false negatives, may require that a human expert, (e.g., a human cyberanalyst who is knowledgeable in techniques for embedding malicious functionality and/or content into malicious HTML webpages and associated attack methods) make such a determination. A human expert may make such a determination by, for example, using a sandboxed web browser to securely and safely access and render a potentially malicious HTML webpage, and then inspect the display and functionality of the webpage. This may indicate that automated HCA methods, such as described herein, may not necessarily be depended on to make a final, binary (Yes/No) determination, but instead may estimate a confidence value or a likelihood/probability (e.g., a value between 0 and 1, or 0% and 100%) that a potentially malicious HTML webpage corresponds to a malicious HTML webpage (e.g., the risk indicator described herein). In at least some applications, for example, the risk indicator may be presented to a human expert who may factor in risk indicator if/when making a determination. In such cases where human expertise may be used to make final determinations and/or decisions, the accuracies of the risk indicator outputted by HCA platform 102 may be improved by combining human-designed, static logic for estimating a likelihood that a potentially malicious HTML webpage corresponds to a malicious HTML webpage.

As an example of how the HCA techniques performed by the HCA platform 102 may be utilized by a cyberanalyst, in some instances, a threat event log of potential threats may be generated (e.g., at a SOC, as part of a cyber security service). The threat event log may include a domain name of a web site (e.g., “www.may-be-badguy.com”) and a determination (e.g., by executing one or more cybersecurity operations, such as Centripetal Network's malicious homoglyphic domain name detection system, as described in U.S. Pat. No. 11,757,901 (the content of which is incorporated herein by reference in its entirety), and/or by the inclusion of the domain name in one or more CTI feeds, etc.) that the web site is potentially malicious. The domain name corresponding to the HTML webpage may be included in a CTI report (that may, e.g., be published/sent by a cyberanalyst). The CSaaS provider CSaaS 104 may include a CTI report in its CTIP 104A system. The CSaaS provider CSaaS 104 may provide the domain name corresponding to, for example, a potentially malicious HTML webpage to the HCA platform 102 as an HTML webpage identified for analysis (e.g., as described at block 201 with respect to FIG. 2), causing the HCA platform 102 to retrieve the potentially malicious HTML webpage and a request to perform HCA on the potentially malicious HTML webpage (e.g., as described at step 510 with respect to FIG. 5). Accordingly, the HCA platform 102 may perform HCA techniques described herein to generate and output a risk indicator for the potentially malicious HTML webpage.

The risk indicator and the potentially malicious HTML webpage may then, in some examples, be reviewed and/or investigated by one or more human cyberanalysts (e.g., at an SOC), who may make a determination as to whether the potentially malicious HTML webpage corresponds to a malicious HTML webpage (e.g., a true positive) or not (e.g., a false positive). Next, the human cyber analysts' output/results/determinations (e.g., especially the true positive malicious HTML webpages) may be used, for example, to improve cyber protections, such as in connection with a CTI feed, notification of CSaaS subscribers/customers of domain names of malicious HTML webpages, machine-learning training databases, Centripetal Network's malicious homoglyphic domain name generation and/or detection systems, as described in U.S. Pat. No. 11,757,901, filed Sep. 16, 2022 and titled “MALICIOUS HOMOGLYHPIC DOMAIN NAME DETECTION AND ASSOCIATED CYBER SECURITY OPERATIONS” which is hereby incorporated by reference in its entirety and/or any other applications described herein. Additionally or alternatively, the human cyber analysts' output/results/determination as to the potentially malicious HTML webpage may be sent to HCA platform 102 in order to retrain and/or otherwise update the content analysis model (e.g., as described below at steps 550-560).

Additionally or alternatively, a cyber security application operated by CSaaS 104 may comprise an SPMS 104B that may collect CTI from multiple CTIPs 104A and transform the CTI into a collection of rules, such as packet filtering rules. In some examples, based on causing output of the risk indicator, the HCA platform 102 may further cause generation of new packet filtering rules and/or updating of existing packet filtering rules. For example, the HCA platform 102 may cause output of the risk indicator to CSaaS 104 which may, in turn, provide the risk indicator to the SPMS 104B. Based on receiving the risk indicator, SPMS 104B may generate one or more packet filtering rules that may have one or more dispositions (e.g., block/drop/deny or allow/forward/permit/pass) and/or directives (e.g., log, capture, etc.) that may be applied to a matching packet (e.g., any matching packet) that includes information, for example a domain name, associated with the potentially malicious HTML webpage or potentially parked/wildcard domain HTML webpage corresponding to the risk indicator. For example, the SPMS 104B may, based on receiving a risk indicator that satisfies a threshold risk value (e.g., the risk indicator corresponds to a high likelihood that the potentially malicious HTML webpage corresponds to a malicious HTML webpage or that the potentially parked/wildcard domain HTML webpage corresponds to a parked/wildcard domain HTML webpage), generate one or more packet filtering rules configured to block/drop/deny any packets associated with the potentially malicious HTML webpage or potentially parked/wildcard domain HTML webpage (e.g., packets sent from/to a web server hosting the potentially malicious HTML webpage or potentially parked/wildcard domain HTML webpage, packets including information to cause a web browser to display the potentially malicious HTML webpage or potentially parked/wildcard domain HTML webpage, and/or other packets associated with the potentially malicious HTML webpage or potentially parked/wildcard domain HTML webpage). In some examples, the SPMS 104B may additionally or alternatively generate one or more packet filtering rules configured to allow/forward/permit/pass any packets associated with the potentially malicious HTML webpage or potentially parked/wildcard domain HTML webpage, based on receiving a risk indicator that does not satisfy a threshold risk value (e.g., the risk indicator corresponds to a low likelihood that the potentially malicious HTML webpage corresponds to a malicious HTML webpage or that the potentially parked/wildcard domain HTML webpage corresponds to a parked/wildcard domain HTML webpage). Additionally or alternatively, the SPMS 104B may update an existing packet filtering rule based on the risk indicator. For example, based on a risk indicator that satisfies a threshold risk value (which may e.g., indicate, in some examples, a low likelihood or, in some instances, a high likelihood, that the potentially malicious HTML webpage corresponds to a malicious HTML webpage or that the potentially parked/wildcard domain HTML webpage corresponds to a parked/wildcard domain HTML webpage). For instance, in updating the one or more packet filtering rules, the SPMS 104B may reconfigure one or more packet filtering rules allowing/forwarding/permitting/passing packets associated with the potentially malicious HTML webpage or potentially parked/wildcard domain HTML webpage to instead block/drop/deny packets associated with the potentially malicious HTML webpage or potentially parked/wildcard domain HTML webpage, or vice versa.

The collection of such packet filtering rules may be referred to as a network protection policy and/or a network security policy. Such a policy/policies may be distributed by an SPMS 104B to subscriber(s), such as a threat intelligence gateway (TIG) (not shown). Note that at least some TIGs may have a capability to compute/determine one or more dispositions (e.g., block/drop or allow/forward) at in-transit packet observation time. For example, a TIG may have a capability to compute/determine a disposition at in-transit packet observation time based on additional threat context information that may not be included in a matching rule (e.g., an HCA risk indicator, time-of-day, if the packet is part of an active port scan attack, if a domain name that may be contained in the packet corresponds to the potentially malicious HTML webpage, and/or the like). For example, the TIG may comprise and/or access an efficient index data structure (e.g., such as the index data structures described in Centripetal Provisional Patent Application No. 63/547,166) comprising HCA risk indicators, generated using HCA techniques described herein, and associated domain names corresponding to the HTML webpages corresponding to the HCA risk indicators. In these examples, the TIG may compute/determine the disposition at in-transit packet observation time based on HCA risk indicators stored at the efficient index data structure. Packet-filtering rules and/or related processes described in U.S. Pat. No. 11,159,546, incorporated by reference herein, may be applied to one or more operations described herein.

A TIG may enforce one or more rules and/or policies that may be enforced by the CSaaS 104. For example, a TIG may comprise a RuleGATE® TIG that may comprise a CleanINTERNET® CSaaS service provided by Centripetal Networks, Inc. A TIG may be placed inline on an enterprise network's Internet access link(s), and/or on the boundary and/or interface between the protected/secured enterprise network and the unprotected/unsecured Internet. Inline placement of the TIG may enable observation of all in-transit packets crossing the boundary (e.g., in one direction or in either direction). A TIG may apply one or more rules and/or policies to each in-transit packet, for example, by searching through the rule/policy for one or more rules/policies that match the packet. The rule's disposition and/or directives may be applied to the packet, for example, if a match is found. A log directive may determine/compute a log of the packet. The log of the packet may be aggregated with logs of other packets comprising the same (or similar) end-to-end communication. For example, packets with the same (or similar) (e.g., up to network address translation (NAT) mapping) 5-tuple values indicating the same (or similar) packet flow and/or end-to-end communication may be aggregated. Because the end-to-end communication may be associated with a threat (e.g., since it may correspond to some CTI), the communication may be indicated and/or referred to as a “threat event.” The associated log of a threat event may be indicated and/or referred to as a “threat event log.”

Referring again to FIG. 5, at step 550, a determination indicating a status of the HTML webpage may be received. For example, a determination indicating whether a potentially malicious HTML webpage corresponds to a malicious HTML webpage may be received. For example, HCA platform 102 may receive a determination (e.g., by a human cyberanalyst) indicating whether, based on analyzing the outputted risk indicator and the potentially malicious HTML webpage (e.g., as described above at step 540), the HTML webpage corresponds to a malicious HTML webpage. The HCA platform 102 may receive the determination from the CSaaS 104 via the communication interface 113.

At step 560, based on receiving the determination indicating the status of the HTML webpage, the content analysis model may be updated. The content analysis model may be updated, for example, based on a determination indicating whether the potentially malicious HTML webpage corresponds to a malicious HTML webpage. For example, the HCA platform 102 may retrain, refine, and/or otherwise update the content analysis model by inputting a new training record into the content analysis model. The new training record may include the BAR for the potentially malicious HTML webpage and the determination indicating whether the potentially malicious HTML webpage corresponds to a malicious HTML webpage.

For example, based on inputting the new training record, the HCA platform 102 may cause the content analysis model to refine, validate, and/or otherwise update its algorithms and/or processes for generating risk indicators for BARs of potentially malicious HTML webpages. For example, the content analysis model may update its algorithms and/or processes based on comparing the stored correlations used by the content analysis model to the determination indicating whether the potentially malicious HTML webpage corresponds to a malicious HTML webpage. In comparing the stored correlations to the determination, the content analysis model may adjust the amount by which the presence or absence of resource identifiers for one or more known assets, included in and/or associated with one or more potentially malicious HTML webpages and present in the BAR for a potentially malicious HTML webpage, affects the risk indicator generated for the potentially malicious HTML webpage.

Consider an example where a BAR for a potentially malicious HTML webpage indicates the potentially malicious HTML webpage includes a total of ten assets: three assets included in and/or associated with known malicious HTML webpages (i.e., “potentially malicious” assets), seven known legitimate assets, and zero known parking assets. The risk indicator for the potentially malicious HTML webpage may have been 30%. Based on comparing a determination that the potentially malicious HTML webpage was malicious to the BAR for the potentially malicious HTML webpage, the content analysis model may update one or more stored correlations to increase the likelihood that similar HTML webpages are malicious HTML webpages in future applications of the content analysis model. For example, the content analysis model may update the stored correlations and/or one or more algorithms such that BARs which indicate a different potentially malicious HTML webpage that includes the same three potentially malicious assets (as well as the same seven legitimate assets and/or different legitimate assets) should receive a risk indicator exceeding 30% in future applications of the content analysis model.

Consider another example where a BAR for a potentially malicious HTML webpage indicates the potentially malicious HTML webpage includes a total of ten assets: seven potentially malicious assets, three legitimate assets, and zero parking assets. The risk indicator for the potentially malicious HTML webpage may have been 70%. Based on comparing a determination that the potentially malicious HTML webpage was not malicious to the BAR for the potentially malicious HTML webpage, the content analysis model may update one or more stored correlations to decrease the likelihood that similar HTML webpages are malicious HTML webpages in future applications of the content analysis model. For example, the content analysis model may update the stored correlations and/or one or more algorithms such that BARs which indicate a different potentially malicious HTML webpage that includes the same seven potentially malicious assets (as well as the same three legitimate assets and/or different legitimate assets) should receive a risk indicator below 70% in future applications of the content analysis model.

It should be understood that the above examples are illustrative and that the content analysis model may be updated in various different methods based on input of the new training model without departing from the scope of this disclosure. It should also be understood that the above examples describing the use of BARs and BAR schemas are illustrative and that any similar feature vectors and/or feature vector schema may be used to perform the HCA techniques described herein without departing from the scope of this disclosure. It should also be further understood that although the examples above are described in terms of (potentially) malicious HTML webpages, similar examples may be described for (potentially) parked/wildcard domain HTML webpages and/or other webpages.

By inputting the new training record into the content analysis model, the HCA platform 102 may create an iterative feedback loop that may dynamically and continuously refine and/or otherwise update the content analysis model to improve its accuracy. In updating the content analysis model, the HCA platform 102 may improve the accuracy and effectiveness of the HCA techniques which may, e.g., result in more efficient training of machine learning models trained by HCA platform 102 (and may in some instances, conserve computing and/or processing power/resources in doing so).

Although certain features and/or steps of performing HCA are described herein as being performed on, with, and/or otherwise with respect to a potentially malicious HTML webpage and/or a potentially parked/wildcard domain HTML webpage, it should be understood that these examples are non-limiting and non-exclusive. For example, an HTML webpage may be both a potentially malicious HTML webpage and a potentially parked/domain wildcard HTML webpage. Also or alternatively, some or all of the features and/or steps described above for performing HCA on a potentially malicious HTML webpage may be applied to performing HCA on a potentially parked/wildcard domain HTML webpage without departing from the scope of this disclosure.

In a CTI-based cyber defense environment such as described herein (e.g., computing environment 100) at least some exemplary cyber security applications may benefit from HCA solutions. For example, computing environment 100 may advantageously identify malicious HTML webpages without the need to execute HTML and/or open a potentially malicious HTML webpage via a web browser. The disclosed comprehensive HCA methods may trade-off one or more performance objectives such as computation time, false positive rates, false negative rates, and/or any other objective, for example, depending on the values of certain parameters. Example solutions described herein may be dynamically configured, and/or “tuned”, to meet one or more performance requirements (e.g., of a given cyber defense application) by setting the associated parameter(s) to one or more values (e.g., certain values).

One or more features discussed herein may be embodied in computer-usable or readable data and/or computer-executable instructions, such as in one or more program modules, executed by one or more computers or other devices as described herein. Program modules may comprise routines, programs, objects, components, data structures, and the like that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. The functionality of the program modules may be combined or distributed as desired. In addition, the functionality may be embodied in whole or in part in firmware or hardware equivalents such as integrated circuits, field programmable gate arrays (FPGA), and the like. Particular data structures may be used to more effectively implement one or more features discussed herein, and such data structures are contemplated within the scope of computer executable instructions and computer-usable data described herein. Various features described herein may be embodied as a method, a computing device, a system, and/or a computer program product.

Although the present disclosure has been described in terms of various examples, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present disclosure may be practiced otherwise than specifically described without departing from the scope and spirit of the present disclosure. Although examples are described above, features and/or steps of those examples may be combined, divided, omitted, rearranged, revised, and/or augmented in any desired manner. Thus, the present disclosure should be considered in all respects as illustrative and not restrictive. Accordingly, the scope of the disclosure should be determined not by the examples, but by the appended claims and their equivalents.

1. A computing device for HTML content analysis, wherein the computer device comprises:
one or more processors; and
memory storing instructions that, when executed by the one or more processors, cause the computing device to:
receive a training set comprising a plurality of training records, wherein each training record comprises, respectively:
a domain name corresponding to an HTML webpage; and
an indication of a previous determination as to whether the corresponding HTML webpage corresponds to a malicious HTML webpage;
generate a feature vector schema for the training set, wherein the feature vector schema corresponds to network assets referenced in the training set, by:
parsing the HTML webpage for each domain name of the training set to generate a set of resource identifiers of network assets referenced in the HTML webpages of the training set, wherein parsing a given HTML webpage comprises:
extracting resource identifiers of each network asset referenced in the given HTML webpage; and
generating the set of resource identifiers based on the extracted resource identifiers of each network asset referenced in the given HTML webpage; and
generating the feature vector schema for the training set based on the generated set of resource identifiers of network assets referenced in the HTML webpages, wherein the feature vector schema maps each position in a feature vector of a given HTML webpage to a corresponding resource identifier of the set of resource identifiers;
process each training record of the training set, using the feature vector schema, to generate a feature vector corresponding to the HTML webpage for each respective domain name of the training set;
train a content analysis model based on inputting, into the content analysis model and for each respective HTML webpage of the training set:
the feature vector of the respective HTML webpage; and
the corresponding indication of the previous determination as to whether the corresponding HTML webpage corresponds to a malicious HTML webpage;
receive a request to perform content analysis on a potentially malicious HTML webpage;
generate, based on the request, a feature vector for the potentially malicious HTML webpage, by processing the potentially malicious HTML webpage using the feature vector schema;
generate, based on inputting the feature vector for the potentially malicious HTML webpage into the content analysis model, a risk indicator, wherein the risk indicator corresponds to a likelihood that the potentially malicious HTML webpage corresponds to a malicious HTML webpage;
cause output of the risk indicator;
receive, based on the output of the risk indicator, feedback corresponding to the accuracy of the risk indicator;
provide the feature vector for the potentially malicious HTML webpage and the feedback to the content analysis model as a new training record; and
update the content analysis model based on the new training record.

2. The computing device of claim 1, wherein processing a given training record comprises:
generating the feature vector for the given training record, wherein the feature vector for the given training record comprises one or more binary bits indicating the presence of resource identifiers, of the set of resource identifiers, in the HTML webpage for each respective domain name by:
determining, based on the feature vector schema and for each position of the feature vector for the given training record, whether the HTML webpage includes a resource identifier corresponding to the resource identifier mapped to the respective position; and
assigning, based on the determining, a binary value to each position of the feature vector for the given training record.

3. The computing device of claim 1, wherein processing the potentially malicious HTML webpage comprises:
extracting resource identifiers corresponding to each network asset referenced in the potentially malicious HTML webpage;
determining, based on the feature vector schema and for each position of the feature vector for the potentially malicious HTML webpage, whether the potentially malicious HTML webpage includes a resource identifier corresponding to the resource identifier mapped to the respective position; and
assigning, based on the determining, a binary value to each position of the feature vector for the potentially malicious HTML webpage.

4. The computing device of claim 1, wherein generating the feature vector schema comprises:
determining, by parsing the set of resource identifiers, whether the set of resource identifiers includes one or more duplicate resource identifiers, wherein the one or more duplicate resource identifiers are each identical to a first resource identifier; and
based on determining the set of resource identifiers includes one or more duplicate resource identifiers, removing, from the set of resource identifiers, each of the one or more duplicate resource identifiers before mapping each position in the feature vector of the given HTML webpage to the corresponding resource identifier of the set of resource identifiers.

5. The computing device of claim 1, wherein generating the feature vector schema comprises:
determining, by parsing the set of resource identifiers, whether the set of resource identifiers includes one or more resource identifiers sharing a same domain name subpart; and
based on determining the set of resource identifiers includes one or more resource identifiers sharing the same domain name subpart, mapping, for two given resource identifiers sharing the same domain name subpart, the two given resource identifiers sharing the same domain name subpart to the same position in the feature vector of the given HTML webpage.

6. The computing device of claim 1, wherein generating the feature vector schema comprises:
determining, by parsing the set of resource identifiers, whether the set of resource identifiers includes one or more alias resource identifiers, wherein a given alias resource identifier corresponds to a known resource identifier included in the set of resource identifiers; and
based on determining the set of resource identifiers includes one or more alias resource identifiers, mapping the given alias resource identifier and the corresponding known resource identifier to the same position in the feature vector of the given HTML webpage.

7. The computing device of claim 1, wherein the receiving the request to perform content analysis is based on monitoring network traffic of a computing device, wherein the monitoring comprises:
identifying a list of HTML webpage domain names included in the network traffic; and
comparing the list of HTML webpage domain names with a watchlist of potentially malicious domain names.

8. The computing device of claim 1, wherein the receiving the request to perform content analysis is based on determining a given HTML webpage exceeds a risk threshold value, wherein the determining comprises:
receiving a set of threat information comprising a plurality of threat records maintained by a cybersecurity application, wherein each threat record comprises:
a domain name corresponding to a tracked HTML webpage; and
a confidence score associated with the domain name corresponding to the tracked HTML webpage, wherein the confidence score indicates a likelihood that the tracked HTML webpage corresponds to a malicious HTML webpage;
receiving an identification of a first HTML webpage;
determining, based on comparing a domain name corresponding to the first HTML webpage to the set of threat information, whether or not the domain name corresponding to the first HTML webpage is included in the set of threat information; and
determining, based on determining that the domain name corresponding to the first HTML webpage is included in the set of threat information and based on comparing the confidence score associated with the domain name of the first HTML webpage to the risk threshold value, whether the confidence score exceeds the risk threshold value.

9. The computing device of claim 1, wherein the feature vector schema further maps a position in the feature vector of the given HTML webpage to a number of webpage redirects associated with a request to access the given HTML webpage.

10. The computing device of claim 1, wherein the instructions, when executed by the one or more processors, cause the computing device to:
determine, based on the feature vector for the potentially malicious HTML webpage, a first network asset absent from the potentially malicious HTML webpage, wherein the first network asset is associated with one or more known malicious HTML webpages;
modify the risk indicator based on determining that the first network asset is absent from the potentially malicious HTML webpage; and
output the modified risk indicator.

11. The computing device of claim 10, wherein the modifying comprises:
determining a weight associated with the first network asset, wherein the weight corresponds to a likelihood that the first network asset indicates a malicious HTML webpage; and
adjusting the risk indicator based on the weight.

12. The computing device of claim 1, wherein the risk indicator comprises:
a confidence score indicating the likelihood that the potentially malicious HTML webpage corresponds to a malicious HTML webpage, wherein the confidence score is based on one or more of:
a determination that a number of network assets, associated with one or more known malicious HTML webpages and identified by the feature vector for the potentially malicious HTML webpage exceeds a threshold number of network assets,
a determination that a percentage of network assets, associated with one or more known malicious HTML webpages and identified by the feature vector for the potentially malicious HTML webpage exceeds a threshold percentage of network assets, or
a determination that a similarity score indicating a correlation between the feature vector for the potentially malicious HTML webpage and one or more feature vectors for one or more HTML webpages corresponding to domain names of the training set exceeds a threshold value.

13. The computing device of claim 1, wherein causing output of the risk indicator causes at least one of:
generation of one or more packet filtering rules configured to block traffic associated with the potentially malicious HTML webpage,
generation of one or more packet filtering rules configured to permit traffic associated with the potentially malicious HTML webpage, or
updating of one or more packet filtering rules configured to perform a first packet filtering action, wherein the updating reconfigures the one or more packet filtering rules to perform a second packet filtering action different from the first packet filtering action.

14. The computing device of claim 1, wherein causing output of the risk indicator causes one or more of:
generation of a first threat intelligence record comprising a domain name corresponding to the potentially malicious HTML webpage, or
updating of a second threat intelligence record, wherein the updated second threat intelligence record comprises the domain name corresponding to the potentially malicious HTML webpage.

15. A method for HTML content analysis, wherein the method comprises:
receiving, by a computing device, a training set comprising a plurality of training records, wherein each training record comprises, respectively:
a domain name corresponding to an HTML webpage; and
an indication of a previous determination as to whether the corresponding HTML webpage corresponds to a malicious HTML webpage;
generating a feature vector schema for the training set, wherein the feature vector schema corresponds to network assets referenced in the training set, by:
parsing the HTML webpage for each domain name of the training set to generate a set of resource identifiers of network assets referenced in the HTML webpages of the training set, wherein parsing a given HTML webpage comprises:
extracting resource identifiers of each network asset referenced in the given HTML webpage; and
generating the set of resource identifiers based on the extracted resource identifiers of each network asset referenced in the given HTML webpage; and
generating the feature vector schema for the training set based on the generated set of resource identifiers of network assets referenced in the HTML webpages, wherein the feature vector schema maps each position in a feature vector of a given HTML webpage to a corresponding resource identifier of the set of resource identifiers;
processing each training record of the training set, using the feature vector schema, to generate a feature vector corresponding to the HTML webpage for each respective domain name of the training set;
training a content analysis model based on inputting, into the content analysis model and for each respective HTML webpage of the training set:
the feature vector of the respective HTML webpage; and
the corresponding indication of the previous determination as to whether the corresponding HTML webpage corresponds to a malicious HTML webpage;
receiving a request to perform content analysis on a potentially malicious HTML webpage;
generating, based on the request, a feature vector for the potentially malicious HTML webpage, by processing the potentially malicious HTML webpage using the feature vector schema;
generating, based on inputting the feature vector for the potentially malicious HTML webpage into the content analysis model, a risk indicator, wherein the risk indicator corresponds to a likelihood that the potentially malicious HTML webpage corresponds to a malicious HTML webpage;
causing output of the risk indicator;
receiving, based on the output of the risk indicator, feedback corresponding to the accuracy of the risk indicator;
providing the feature vector for the potentially malicious HTML webpage and the feedback to the content analysis model as a new training record; and
updating the content analysis model based on the new training record.

16. The method of claim 15, wherein causing output of the risk indicator causes at least one of:
generation of one or more packet filtering rules configured to block traffic associated with the potentially malicious HTML webpage,
generation of one or more packet filtering rules configured to permit traffic associated with the potentially malicious HTML webpage, or
updating of one or more packet filtering rules configured to perform a first packet filtering action, wherein the updating reconfigures the one or more packet filtering rules to perform a second packet filtering action different from the first packet filtering action.

17. The method of claim 15, wherein causing output of the risk indicator causes one or more of:
generation of a first threat intelligence record comprising a domain name corresponding to the potentially malicious HTML webpage, or
updating of a second threat intelligence record, wherein the updated second threat intelligence record comprises the domain name corresponding to the potentially malicious HTML webpage.

18. One or more non-transitory computer-readable media having instructions stored thereon for HTML content analysis that, when executed by one or more computing devices, cause the computing devices to:
receive a training set comprising a plurality of training records, wherein each training record comprises, respectively:
a domain name corresponding to an HTML webpage; and
an indication of a previous determination as to whether the corresponding HTML webpage corresponds to a malicious HTML webpage;
generate a feature vector schema for the training set, wherein the feature vector schema corresponds to network assets referenced in the training set, by:
parsing the HTML webpage for each domain name of the training set to generate a set of resource identifiers of network assets referenced in the HTML webpages of the training set, wherein parsing a given HTML webpage comprises:
extracting resource identifiers of each network asset referenced in the given HTML webpage; and
generating the set of resource identifiers based on the extracted resource identifiers of each network asset referenced in the given HTML webpage; and
generating the feature vector schema for the training set based on the generated set of resource identifiers of network assets referenced in the HTML webpages, wherein the feature vector schema maps each position in a feature vector of a given HTML webpage to a corresponding resource identifier of the set of resource identifiers;
process each training record of the training set, using the feature vector schema, to generate a feature vector corresponding to the HTML webpage for each respective domain name of the training set;
train a content analysis model based on inputting, into the content analysis model and for each respective HTML webpage of the training set:
the feature vector of the respective HTML webpage; and
the corresponding indication of the previous determination as to whether the corresponding HTML webpage corresponds to a malicious HTML webpage;
receive a request to perform content analysis on a potentially malicious HTML webpage;
generate, based on the request, a feature vector for the potentially malicious HTML webpage, by processing the potentially malicious HTML webpage using the feature vector schema;
generate, based on inputting the feature vector for the potentially malicious HTML webpage into the content analysis model, a risk indicator, wherein the risk indicator corresponds to a likelihood that the potentially malicious HTML webpage corresponds to a malicious HTML webpage;
cause output of the risk indicator;
receive, based on the output of the risk indicator, feedback corresponding to the accuracy of the risk indicator;
provide the feature vector for the potentially malicious HTML webpage and the feedback to the content analysis model as a new training record; and
update the content analysis model based on the new training record.

19. The one or more non-transitory computer-readable media of claim 18, wherein the instructions, when executed by the one or more computing devices, further cause the computing devices to cause output of the risk indicator by causing at least one of:
generation of one or more packet filtering rules configured to block traffic associated with the potentially malicious HTML webpage,
generation of one or more packet filtering rules configured to permit traffic associated with the potentially malicious HTML webpage, or
updating of one or more packet filtering rules configured to perform a first packet filtering action, wherein the updating reconfigures the one or more packet filtering rules to perform a second packet filtering action different from the first packet filtering action.

20. The one or more non-transitory computer-readable media of claim 18, wherein the instructions, when executed by the one or more computing devices, further cause the computing devices to cause output of the risk indicator by causing one or more of:
generation of a first threat intelligence record comprising a domain name corresponding to the potentially malicious HTML webpage, or
updating of a second threat intelligence record, wherein the updated second threat intelligence record comprises the domain name corresponding to the potentially malicious HTML webpage.
